(19) United States
(12) Patent Application Publication
(10) Pub. No.: US 2007/0227388 A1
(43) Pub. Date: Oct. 4, 2007

(54) Tetrakisazo Compound, Coloring Matter for Recording, Ink Composition and Colored Article

(76) Inventors: Hiroaki Ohno, Kita-ku (JP); Takahiko Matsui, Kita-ku (JP); Takashi Yoneda, Kita-ku (JP); Yasuo Shirasaki, Saitama-shi (JP); Yoshiaki Kawaida, Kita-ku (JP)

Correspondence Address: NIELDS & LEMACK, 176 EAST MAIN STREET, SUITE 7, WESTBORO, MA, 01581, US

(21) Appl. No.: 11/579,289

(22) PCT Filed: May 9, 2005
(86) PCT No.: PCT/JP05/08438

§ 371 Date: Nov. 2, 2006

(30) Foreign Application Priority Data
May 10, 2004 (JP) 2004-139412

(51) Int. Cl. C09B 31/02; B41M 3/00; C09D 11/00

(52) U.S. Cl. 101/483; 106/31.13; 534/732

(57) ABSTRACT

The present invention relates to black coloring matter, and relates to a compound represented by the following formula (1): 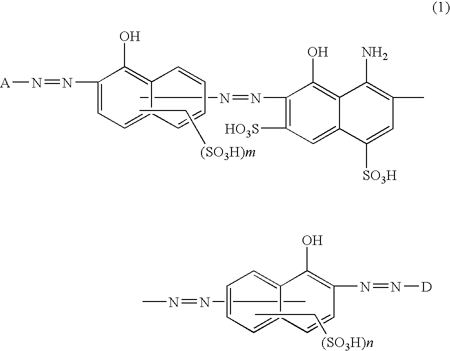 (wherein A and D independently represent an optionally substituted phenyl group or naphthyl group, respectively, and m and n represent 1 or 2, respectively), and the coloring matter for recording and an ink comprising the same. Said compound exhibits high solubility in a medium containing water as a main component, is stable even when an aqueous dye solution or an ink having a high concentration is prepared therefrom and is stored for a long period of time, has low color rendering property, exhibits colorless and neutral black, provides a printed image having high density and also provides a black recorded image being excellent in moisture fastness, light fastness and an ozone gas fastness, and further can be synthesized easily and can be produced at a low cost.

### TECHNICAL FIELD

The present invention relates to a novel water-soluble tetrakisazo compound or a salt thereof, a coloring matter for recording, an ink composition comprising the same, and a colored article thereby.

### BACKGROUND OF THE INVENTION

Coloring matter expressing black is used for printing not only black character information but also color images. However, because development of coloring matter expressing black with neutral hue and high density has a number of technical difficulties, few have enough performance though tremendous research and development has been done. Therefore, a plural of various coloring matters are mixed to form black and development of coloring matter expressing neutral black with high density on its alone is the most strongly desirable technical problem.

A method for recording by means of an ink-jet printer, a typical method among various color recording methods, records by generating ink droplets and depositing them onto various record-receiving materials (such as paper, film and cloth). This method has been rapidly prevailing lately and is expected to grow remarkably in the future because of such features as less noise generation due to no contact of a recording head with a record-receiving material and easiness in downsizing and speedup. Conventionally, as an ink for a fountain pen or a felt pen and an ink for ink-jet recording, a water-based ink dissolving a water-soluble dye in a aqueous medium has been used, and in these water-soluble inks, a water-soluble organic solvent is generally added to prevent ink from clogging at a pen tip or an ink-jet nozzle. For this reason, these conventional inks are required to provide a recorded image of sufficient density, not to clog at a pen tip or an ink-jet nozzle, to dry quickly on a record-receiving material, to bleed less, to have good storage stability and, in particular, to have high solubility in water and a water-soluble organic solvent to be added to the inks. Moreover, an image formed is required to have image fastness such as water fastness, light fastness, ozone gas fastness and moisture fastness.

Ozone gas fastness, called ozone fastness or gas fastness in short, means durability against phenomenon that oxidizing ozone gas in the air reacts with a dye on a recorded paper to incur discoloration or fading of a printed image. Oxidizing gas having this kind of action includes NOx and SOx besides ozone gas. Ozone gas is considered particularly to be a main causative substance to promote the phenomenon of discoloration or fading of an ink-jet recorded image more strongly among various oxidizing gases, and used for acceleration test to know about degree of ozone gas fastness. The phenomenon of discoloration or fading by these oxidizing gases is peculiar to ink-jet images, and therefore improvement of ozone gas fastness has been an important problem. In particular, porous materials such as inorganic white pigments and the like for an ink-receiving layer provided on the surface in a ink-jet professional paper for photographic quality image are often used to dry the ink faster and to decrease bleed in a high quality image and discoloration or fading in color caused by ozone gas occurs noticeably on such papers recorded.

Moisture fastness means durability to the phenomenon that coloring matter for dyeing in record-receiving materials is blurred while colored record-receiving materials are stored under an atmosphere of high humidity. For blur of coloring matter for dyeing significantly decrease image qualities of an image required for high precision image qualities especially such as a photographic image, it is important to cause as less blur as possible. Consequently, moisture fastness is also an important subject required in coloring matter for ink-jet as well as the above ozone gas fastness.

To extend application field of a printing method using ink in the future, an ink composition to be used for ink-jet recording and a colored article thereby are strongly required to exhibit further improvement water fastness, light fastness, moisture fastness and ozone gas fastness.

Among inks with various hues prepared from various dyes, a black ink is an important one used for both of mono color and full color images. So far many dye stuffs for black inks have been proposed, however, a product sufficiently satisfying market needs has not yet been provided. Many of coloring matters proposed up to the present are disazo ones, which have problems that they have too shallow hues (black tinged with red), high color rendering, less water and/or moisture fastness, insufficient ozone gas fastness and the like. Moreover, similarly, in the case of metal containing azo coloring matter often proposed, they have problems such that considerations for safety to human bodies and environment are not enough because they contain metal ions, and ozone gas fastness is not sufficient. Trisazo coloring matter and tetrakisazo coloring matter where the number of conjugated bonds was increased to deepen hues, leave problems such as low hue density, poor solubility in water, poor storage stability in solution and ink, and insufficient ozone gas fastness.

Tetrakisazo compounds of which conjugated bonds was increased were proposed in Patent Literatures 1 to 3, but any product satisfying market needs sufficiently has not been supplied.
Patent Literature 1: JP Laid-Open No.302220/1996
Patent Literature 2: JP Laid-Open No.302221/1996
Patent Literature 3: JP Laid-Open No.12910/1997
Patent Literature 4: JP Patent No.2565531
Patent Literature 5: JP Laid-Open No. 286421/2003
Patent Literature 6: WO 00/43451
Patent Literature 7: WO 00/43453

### DISCLOSURE OF THE INVENTION

### Problems to Be Solved by the Invention

An object according to the present invention is to provide a coloring matter for a black ink that has high solubility in medium whose main component is water, stability in long-term storage of high concentrated dye water solution and ink, and expression of neutral black with no other colors, high density of a printed image, and that gives black recorded images excellent in moisture fastness, light fastness, and ozone gas fastness, and furthermore that is easily synthesized and inexpensive, and an ink composition thereof.

### Means of Solving the Problems

The inventors intensively studied a way to solve the above problems, and thus have completed the present invention. That is, the present invention relates to:
(1) A compound or a coloring matter for recording represented by the following Formula (1) in the free acid form, 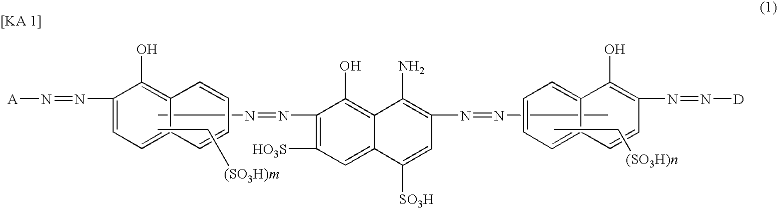
   (wherein, each of A and D independently represents a phenyl group or a naphthyl group which may be substituted, and each of m and n represents 1 or 2),
(2) A coloring matter for recording represented by the following Formula (2) in the free acid form, 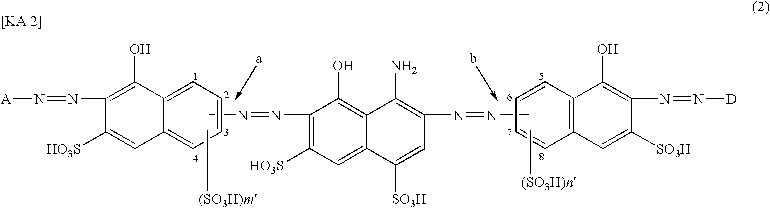
   (Wherein, each of A and D has the same meaning in Formula (1) of the above aspect (1). Each of m′ and n′ represents 0 or 1. The bonding position of bond a is the 2- or 3-position, and the bonding position of bond b is the 6- or 7-position),
(3) The compound or the coloring matter for recording according to the above aspect (2), wherein, in Formula (2), each of m′ and n′ represents 1, the bonding positions of the sulfo group are respectively the 4-position and the 8-position, the bonding position of bond a is the 3-position, and the bonding position of bond b is the 7-position,
(4) The coloring matter for recording according to the above aspect (1) or (2), wherein a substituent on A and D in Formula (1) or Formula (2) is a halogen atom; a hydroxyl group; an amino group; a carboxyl group; a sulfo group; a phosphono group; a nitro group; an alkyl group; an alkoxy group; an acyl group; a phenyl group; a ureide group; an alkyl group substituted with a hydroxyl group, an alkoxy group, a sulfo group or a carboxyl group; an alkoxy group substituted with a hydroxyl group, an alkoxy group, a sulfo group or a carboxyl group; a phenyl group which may be substituted with a carboxy group or a sulfo group; an amino group substituted with an alkyl group or an acyl group; a benzothiazole group; a mesyl group; or a sulfamoyl group,
(5) The coloring matter for recording according to the above aspects (1) to (4), wherein each of A and D in Formula (1) or Formula (2) is independently a phenyl group or a naphthyl group which may be substituted with a group selected from a halogen atom, a carboxyl group, a sulfo group, a nitro group, an alkoxy group, a sulfoalkoxy group, an acylamino group, a benzothiazole group, a mesyl group, and a sulfamoyl group,
(6) The coloring matter for recording according to any one of the above aspects (1) to (5), wherein each of A and D in Formula (1) or Formula (2) is a phenyl group or a naphthyl group substituted with one or more carboxyl groups or sulfo groups,
(7) The coloring matter for recording according to the above aspect (2), wherein each of A and D in Formula (2) is a phenyl group which has a sulfo group or a carboxyl group at 2-position to an azo group and a hydrogen atom, a nitro group or an alkoxy group at 4-position to an azo group; or a phenyl group which has carboxyl groups at 2-position and 5-position or at 3-position and 5-position to an azo group, and, when m′ is 1, the bonding position is 3-position or 4-position and, when n′ is 1, the bonding position is 7-position or 8-position,
(8) An ink composition characterized by comprising the coloring matter for recording according to any one of the above aspects (1) to (7),
(9) An recording method for ink-jet printing characterized by using the ink composition according to the above aspect (8) as an ink in a method for ink-jet recording where recording is conducted on a record-receiving material by jetting ink droplet in response to a recording signal,
(10) The recording method for ink-jet printing according to the above aspect (9), wherein a record-receiving material is a sheet for transmitting information,
(11) An ink-jet printer loaded with a container containing the ink composition according to the above aspect (8),
(12) A colored article colored with the coloring matter for recording according to any one of the above aspects (1) to (7),
(13) A tetrakisazo compound represented by the following Formula (1′) or a salt thereof, 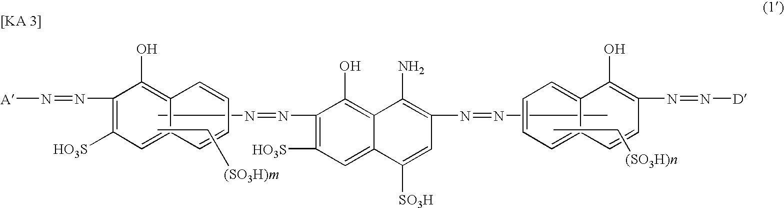
   (wherein, each of A′ and D′ independently represents a phenyl group or a naphthyl group, which may be substituted with a halogen atom; a hydroxyl group; an amino group; a carboxyl group; a sulfo group; a nitro group; an alkyl group; an alkoxy group; an acyl group; a phenyl group; a ureide group; an alkyl group substituted with a hydroxyl group, an alkoxy group, a sulfo group or a carboxyl group; an alkoxy group substituted with a hydroxyl group, an alkoxy group, a sulfo group or a carboxyl group; an amino group substituted with a phenyl group which may be substituted with a carboxyl group or a sulfo group, an alkyl group or an acyl group; an benzothiazole group; a mesyl group; or a sulfamoyl group. m and n represent 1 or 2),
(14) The tetrakisazo compound according to the above aspect (13) or a salt thereof, wherein A′ and D′ in Formula (1′) are a halogen atom; a hydroxyl group; a lower acylamino group; a carboxyl group; a sulfo group; a nitro group; a lower alkyl group; a lower alkoxy group which may be substituted with a sulfo group; a benzothiazole group which may have a lower alkyl group or a sulfo group on a benzene nucleus as a substituent; a phenyl group or a naphthyl group which may be substituted with 1 to 3 of substituents selected from a group consisting of a phosphono group, a mesyl group and a sulfamoyl group,
(15) The tetrakisazo compound or the salt thereof according to the above aspect (14), wherein the naphthyl groups in the left and right sides substituted with the azo group in Formula (1′) are bound at 3-position and 7-position respectively to the azo group bound to a naphthyl group in the center, where 3-position and 7-position represent the positions when a naphthyl group is assigned the same number as in the above Formula (2),
(16) The tetrakisazo compound or the salt thereof according to the above aspect (13), wherein each of A′ and D′ in Formula (1′) is a phenyl group or a naphthyl group substituted with one or more carboxyl groups or sulfo groups,
(17) A tetrakisazo compound according to the above aspect (13) represented by the following Formula (a) in the free acid form or a salt thereof, 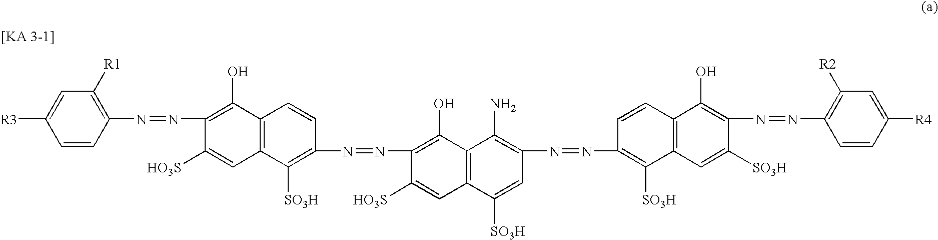
   (wherein, each of R1 and R2 independently represents a hydrogen atom, a sulfo group or a carboxyl group, each of R3 and R4 independently represents a nitro group, a lower alkylsulfonyl group or a sulfamoyl group),
(18) The tetrakisazo compound or the salt thereof according to the above aspect
(17), wherein, in Formula (a), R1 and R2 represent the same group selected from a hydrogen atom, a sulfo group or a carboxyl group, and R3 and R4 are the same group selected from a nitro group, a mesyl group or a sulfamoyl group,
(19) The tetrakisazo compound or the salt thereof according to the above aspect (18), wherein in Formula (a), R3 and R4 are sulfamoyl groups or mesyl groups when R1 and R2 are hydrogen atoms, R3 and R4 are sulfamoyl groups when R1 and R2 are carboxyl groups, and R3 and R4 are nitro groups when R1 and R2 are sulfo groups.

### Effect of the Invention

A tetrakisazo compound of the present invention has excellent water-solubility, therefore a filtration property with a membrane filter during production steps of ink composition is favorable, and it exhibits excellent stability in storage of a recording solution and jet stability. Furthermore, an ink composition comprising the tetrakisazo compound of the present invention does not exhibit crystal deposition, change in physical property, or color change after storage for a long period of time, and exhibits favorable storage stability. And an ink composition comprising the tetrakisazo compound of the present invention is used for ink-jet recording, and for writing tools, and when a recording image is made on a plain paper and a professional paper for ink-jet, printing density of a recorded image is high, and in addition, a recorded image is excellent in ozone gas fastness, light fastness and moisture fastness, and has small color rendering properties. By using it together with a magenta, a cyan, and a yellow dye, full-colored ink-jet recording with excellence in light fastness and water fastness is possible. Thus an ink composition of the present invention is extremely useful as a black ink for ink-jet recording.

### BEST MODE FOR CARRYING OUT THE INVENTION

The present invention will be described in detail hereinafter.

In Formulas (1), (2) and (1′), each of A and D independently represents a phenyl group or a naphthyl group. And these may be respectively substituted or unsubstituted. As a group, for example, a halogen atom such as chlorine and bromine; a hydroxyl group; an unsubstituted amino group; a carboxyl group; a sulfo group; a phosphono group; a nitro group; an alkyl group such as methyl, ethyl, n-propyl, isopropyl, n-butyl, isobutyl, sec-butyl and tert-butyl, preferably a lower alkyl group, for example, a (C1 to C4) alkyl group; an alkoxy group such as methoxy and ethoxy, preferably a lower alkoxy group, for example, a (C1 to C4) alkoxy group; an alkoxy group substituted with a hydroxyl group, an alkoxy group, a sulfo group or a carboxyl group such as 2-hydroxyethoxy, 2-methoxyethoxy, 3-sulfopropoxy and 4-sulfobutoxy, preferably a lower alkoxy group substituted with the above substituents, for example, an (C1 to C4) alkoxy group substituted with the above substituents; a carboxyl group; a sulfo group; an amino group (a substituted amino group) substituted with a phenyl group, an alkyl group or an acyl group; an acyl group; a phenyl group; a ureide group; an alkyl group substituted with a hydroxyl group, an alkoxy group, a sulfo group or a carboxyl group; a benzothiazole group which may be substituted with a lower alkyl group or/and a sulfo group; a mesyl group; and a sulfamoyl group are included. In this connection, a phenyl group, an alkyl group or an acyl group which are the above substituents of a substituted amino may further have a substituent, and as said substituent, for example, an hydroxyl group, an alkoxy group, a carboxyl group or a sulfo group are included. As a substituted amino group, for example, carboxymethylamino, carboxypropylamino, bis-carboxymethylamino, acetylamino, ureide, phenylamino, sulfophenylamino, carboxyphenylamino, dicarboxyphenylamino, and the like are included.

Preferable A and D are a halogen atom; a carboxyl group; a sulfo group; a nitro group; an unsubstituted alkoxy group, preferably an unsubstituted lower alkoxy group, more preferably a methoxy group; a sulfoalkoxy group, preferably a sulfo-lower alkoxy group; an acylamino group, preferably a lower acylamino group, more preferably an acetylamino group; a benzothiazole group which may be substituted with a lower alkyl group or/and a sulfo group; and a phenyl group or a naphthyl group which may be substituted with a mesyl group or a sulfamoyl group, and in addition, A and D preferably have one or more carboxyl groups or sulfo groups as a substituent.

Unless otherwise especially specified in the description, such terms as alkyl, alkoxy, acyl, alcohol and alkanol particularly have no limitation in the number of carbons, however, the number of carbons is preferably 20 or less, more preferably 15 or less, further preferably 10 or less. In addition, the word “lower”, unless otherwise especially specified, is used as a meaning of “C1 to C6”, preferably “C1 to C4”.

As suitable compounds represented by Formula (1) of the present invention, especially not limited, the following compounds can be listed for a typical example. In this connection, in Table 1, a sulfo group, a carboxyl group and a phosphono group are represented in the free acid form.

TABLE 1

| Comp. | |
|---|---|
| No. | Structural Formula |
| No. 1 | 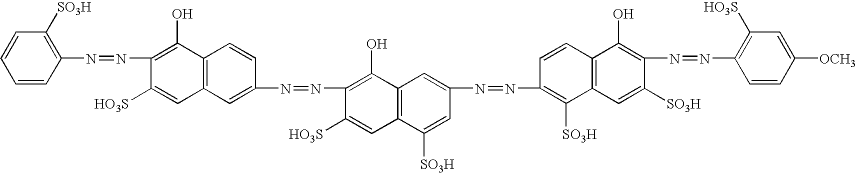 |
| No. 2 | 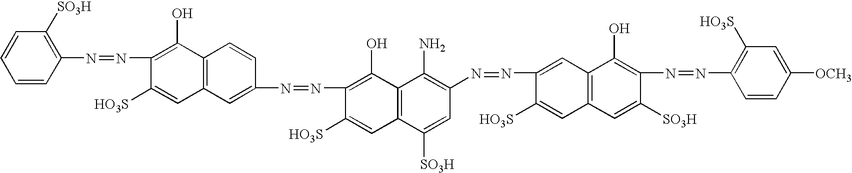 |
| No. 3 | 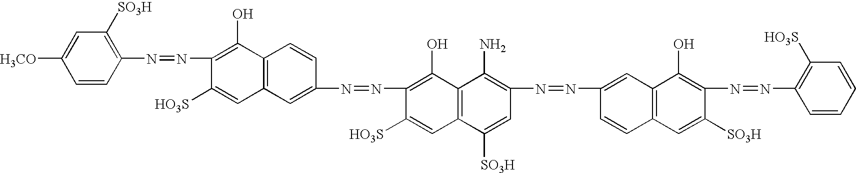 |
| No. 4 | 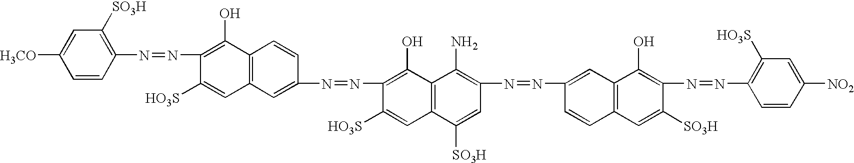 |
| No. 5 | 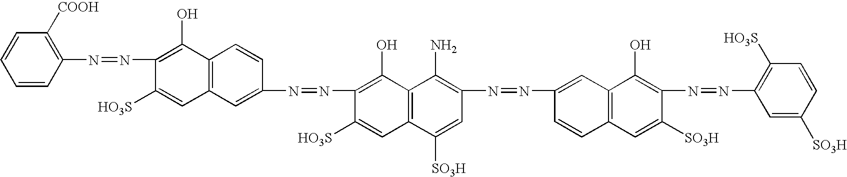 |
| No. 6 | 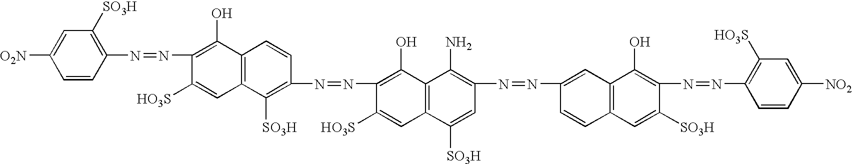 |
| No. 7 | 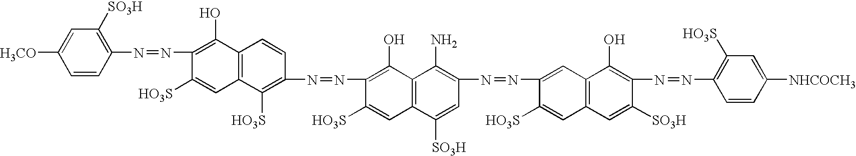 |
| No. 8 | 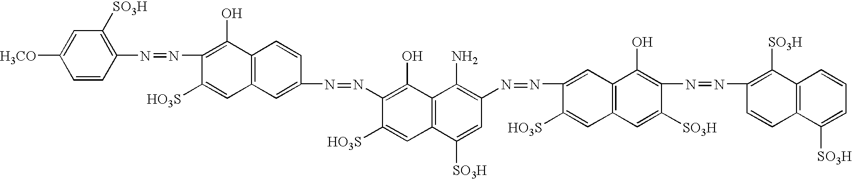 |
| No. 9 | 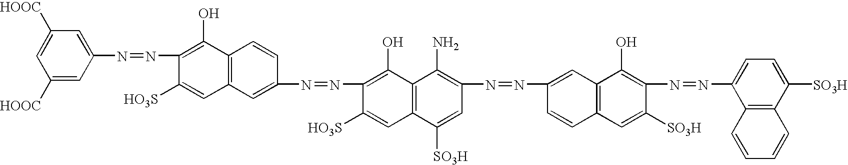 |
| No. 10 | 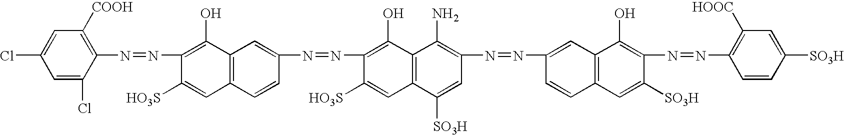 |

TABLE 2

| | |
|---|---|
| No. 11 | 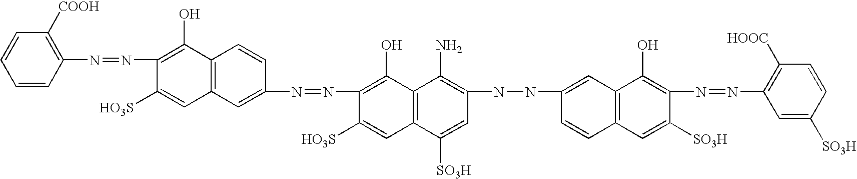 |
| No. 12 | 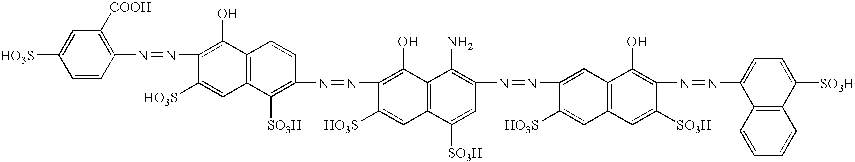 |
| No. 13 | 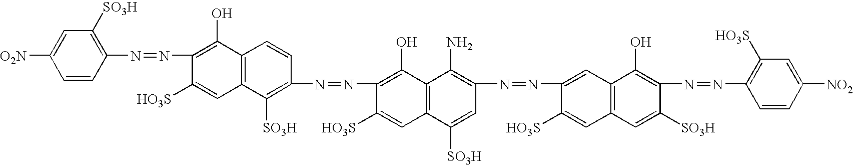 |
| No. 14 | 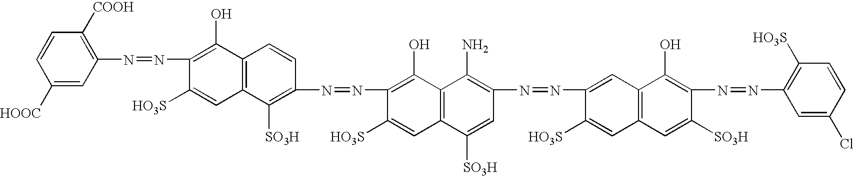 |
| No. 15 | 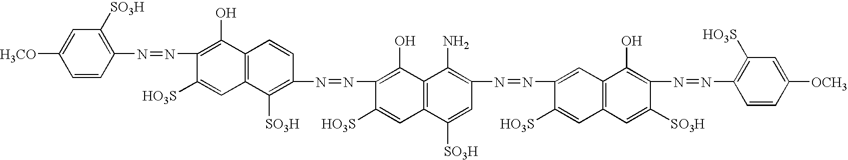 |
| No. 16 | 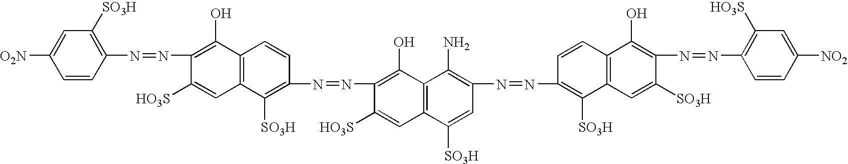 |
| No. 17 | 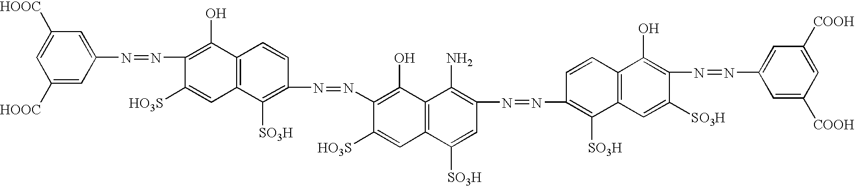 |
| No. 18 | 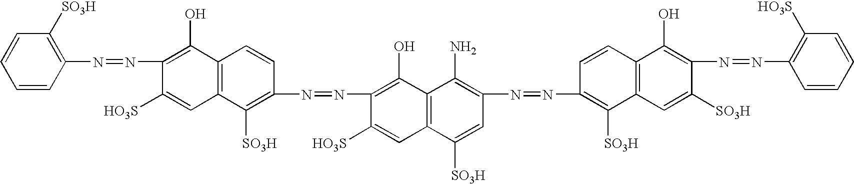 |
| No. 19 | 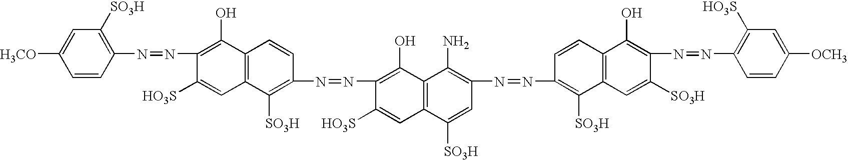 |
| No. 20 | 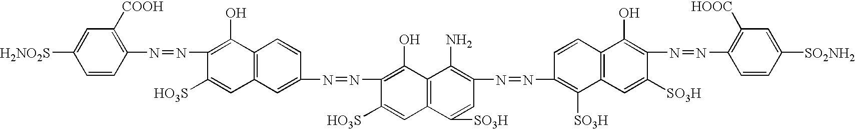 |

TABLE 3

| | |
|---|---|
| No. 21 | 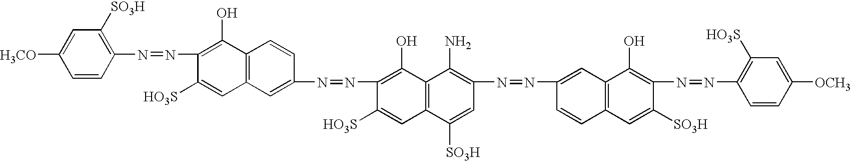 |
| No. 22 | 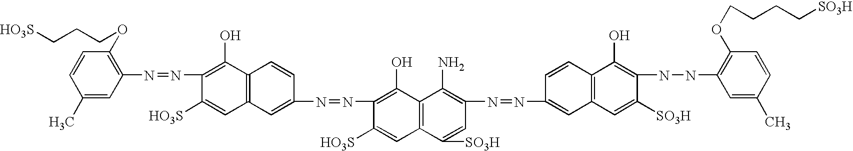 |
| No. 23 | 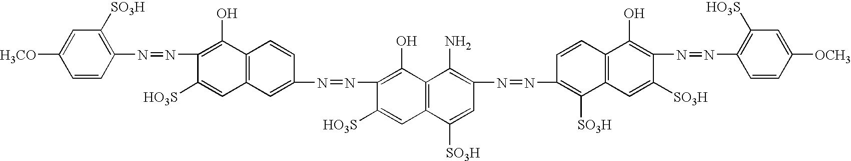 |
| No. 24 | 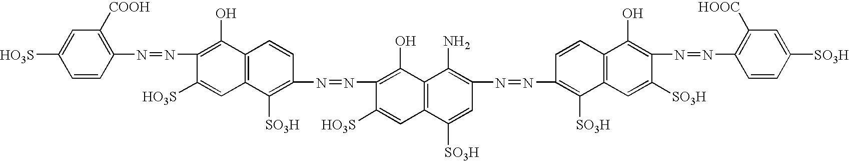 |
| No. 25 | 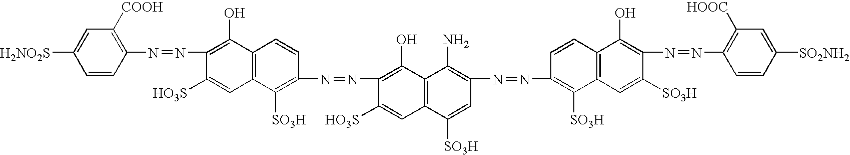 |
| No. 26 | 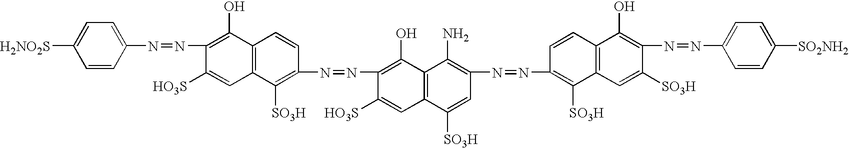 |
| No. 27 | 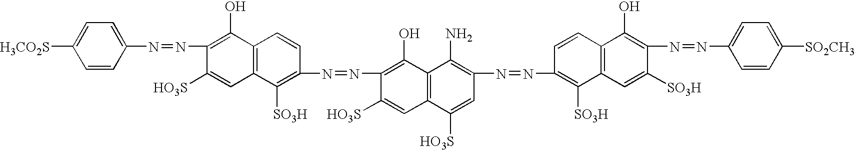 |
| No. 28 | 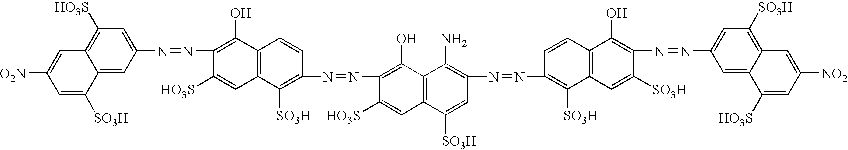 |
| No. 29 | 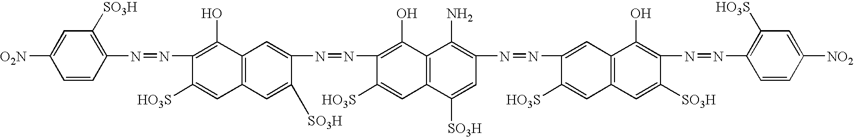 |
| No. 30 | 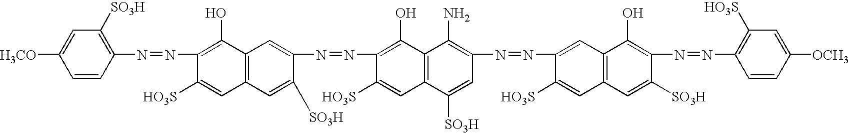 |

TABLE 4

| No. 31 | 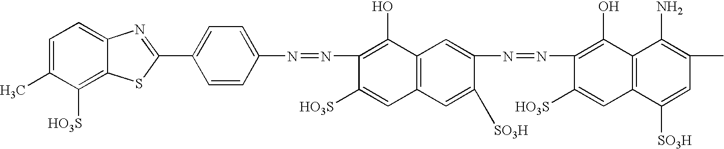 |
|---|---|
| | 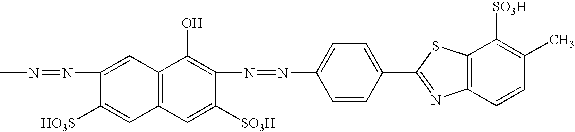 |
| No. 32 | 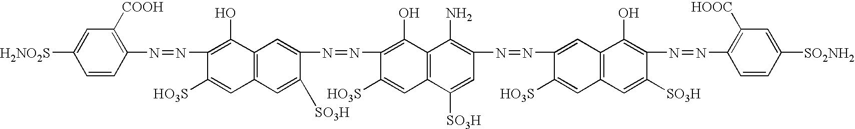 |
| No. 33 | 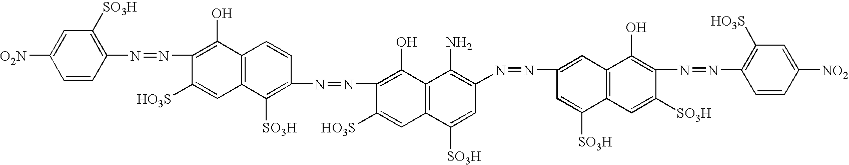 |
| No. 34 | 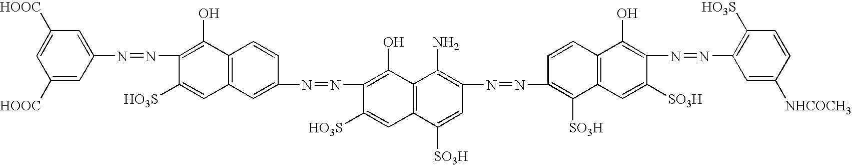 |
| No. 35 | 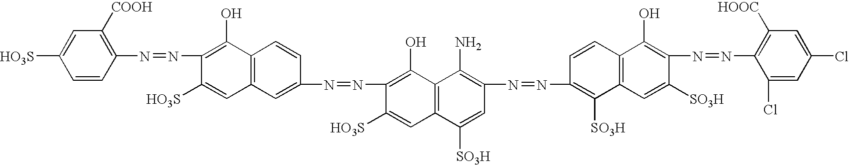 |
| No. 36 | 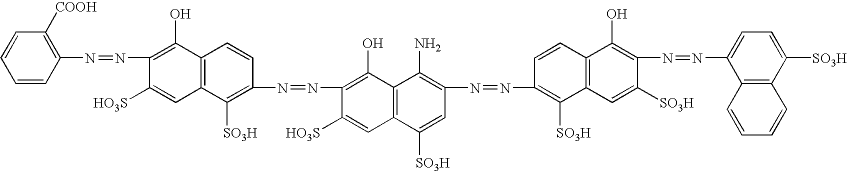 |
| No. 37 | 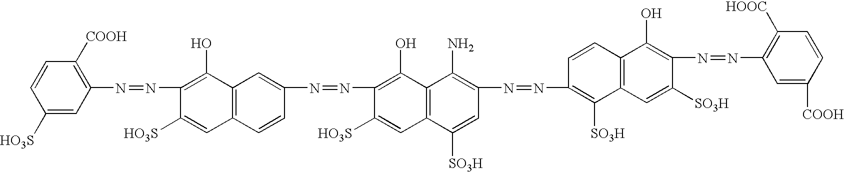 |
| No. 38 | 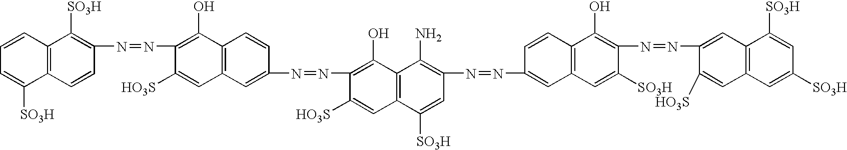 |
| No. 39 | 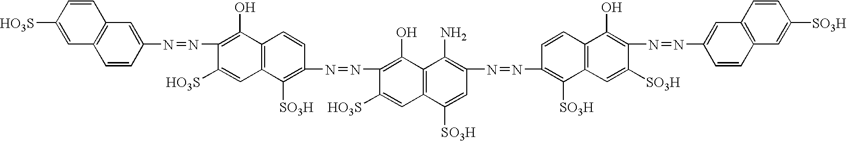 |
| No. 40 | 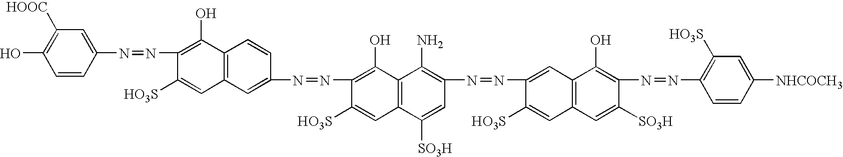 |

TABLE 5

| | |
|---|---|
| No. 41 | 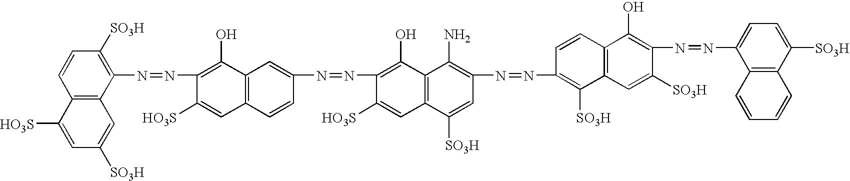 |
| No. 42 | 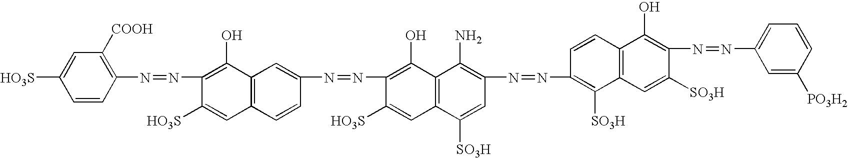 |

Among the compounds of the above Formula (1), as a preferable compound, the compounds represented by Formula (1′) or the compounds represented by Formula (2) can be included.

In Formula (2), such a compound that m′ and n′ represent 1 respectively, such a compound that the substitution positions of the sulfo group are 4-position and 8-position respectively, the bonding position of bond a is 3-position, and the bonding position of bond b is 7-position is a preferable compound for a coloring matter for recording, more specifically, such a compound that A and D in Formula (2) are respectively A′ and D′ (in this regard, A′ and D′ are the same as in Formula (1′)). As a more preferable compound, such a compound that A and D are a halogen atom; a hydroxyl group; a lower acylamino group; a carboxyl group; a sulfo group; a nitro group; a lower alkyl group; a lower alkoxy group which may be substituted with a sulfo group; a benzothiazole group which may has a lower alkyl group or a sulfo group as a substituent on a benzene nucleus; or a phenyl group or a naphthyl group which may be substituted with 1 to 3 of the substituents selected from group consisting of a phosphono group, a mesyl group or a sulfamoyl group can be included. As the most preferable A and D, respectively independently, 4-sulfamoylphenyl, 4-mesylphenyl, 2-carboxyl-4-sulfamoylphenyl or 2-sulfo-4-nitrophenyl can be included, more preferably the both are the same group.

The compounds shown in the above Formula (1), Formula (2) and Formula (1′) exist in the free acid form or in the form of salt thereof. In the present invention, a salt of inorganic or organic cation can be cited as the salt. As a specific example of an inorganic salt, an alkali metal salt and an ammonium salt can be cited, a preferable inorganic salt is a salt of lithium, sodium and potassium, and an ammonium salt, and as a salt of organic cation, for example, a salt of a compound shown in the following Formula (3) can be cited, but not limited thereto.

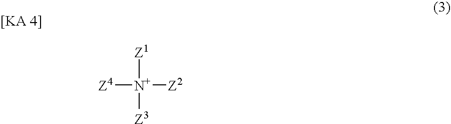

Each of Z¹, Z², Z³ and Z⁴ in Formula (3) independently represents a hydrogen atom, an alkyl group, a hydroxyalkyl group or a hydroxyalkoxyalkyl group. For Z¹, Z², Z³ and Z⁴, an example of an alkyl group includes methyl, ethyl, n-propyl, isopropyl, n-butyl, isobutyl, sec-butyl and tert-butyl, an example of a hydroxylalkyl group includes a hydroxy-(C1 to C4)alkyl group such as a hydroxymethyl group, a hydroxyethyl group, a 3-hydroxypropyl group, a 2-hydroxypropyl group, a 4-hydroxybutyl group, a 3-hydroxybutyl group and 2-hydroxybutyl, an example of a hydroxyalkoxyalkyl group includes hydroxyl(C1 to C4)alkoxy-(C1 to C4)alkyl group such as a hydroxyethoxymethyl group, a 2-hydroxyethoxyethyl group, a 3-hydroxyethoxypropyl group, a 2-hydroxyethoxypropyl group, a 4-hydroxyethoxybutyl group, a 3-hydroxyethoxybutyl group and 2-hydroxyethoxybutyl group, and a hydroxyethoxy-(C1 to C4) alkyl group is preferable among them. For Z¹, Z², Z³ and Z⁴, especially preferable one includes, respectively independently, a hydrogen atom; a methyl group; a hydroxy-(C1 to C4)alkyl group such as a hydroxymethyl group, a hydroxyethyl group, a 3-hydroxypropyl group, a 2-hydroxypropyl group, a 4-hydroxybutyl group, a 3-hydroxybutyl group and a 2-hydroxybutyl group; and a hydroxyethoxy-(C1 to C4)alkyl group such as a hydroxyethoxymethyl group, a 2-hydroxyethoxyethyl group, a 3-hydroxyethoxypropyl group, a 2-hydroxyethoxypropyl group, a 4-hydroxyethoxybutyl group, a 3-hydroxyethoxybutyl group and a 2-hydroxyethoxybutyl group.

Specific examples of Formula (3) are shown in Table 6.

TABLE 6

| Compound No. | Z¹ | Z² | Z³ | Z⁴ |
|---|---|---|---|---|
| 4-1 | H | —C2H4OH | —C2H4OH | —C2H4OH |
| 4-2 | CH3 | —C2H4OH | —C2H4OH | —C2H4OH |
| 4-3 | H | —CH2CH(OH)CH3 | —CH2CH(OH)CH3 | —CH2CH(OH)CH3 |
| 4-4 | CH3 | —CH2CH(OH)CH3 | —CH2CH(OH)CH3 | —CH2CH(OH)CH3 |
| 4-5 | H | —C2H4OH | H | —C2H4OH |
| 4-6 | CH3 | —C2H4OH | H | —C2H4OH |
| 4-7 | H | —CH2CH(OH)CH3 | H | —CH2CH(OH)CH3 |
| 4-8 | CH3 | —CH2CH(OH)CH3 | H | —CH2CH(OH)CH3 |
| 4-9 | CH3 | —C2H4OH | CH3 | —C2H4OH |
| 4-10 | CH3 | —CH2CH(OH)CH3 | CH3 | —CH2CH(OH)CH3 |

The tetrakisazo compound of the present invention as shown in Formula (1), (2), (1′) and (a), for example, in the case of the compound shown in Formula (2), can be synthesized in the following method (A compound structure of each process is represented in the free acid form.). That is, a compound represented by the following Formula (4) is reacted with a compound represented by the following Formula (5)

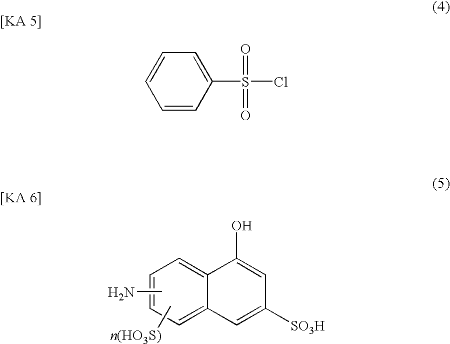

(wherein, n represents the same meaning as n′ in Formula (2). Hereinafter, the same as in the Formulas for the synthetic reactions described below), under weakly alkaline conditions to obtain a compound represented by the following Formula (6)

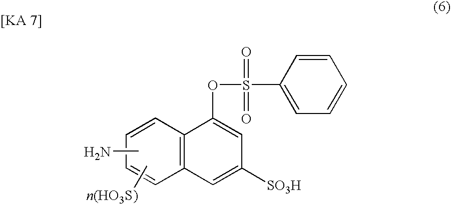

(wherein, n represents the same meaning as in the above Formula (5)).

This obtained compound is diazotized in a conventional manner, and then the diazotized compound is subjected to acidic coupling with 4-amino-5-hydroxynaphthalene-1,7-disulfonic acid to obtain a compound represented by the following Formula (7)

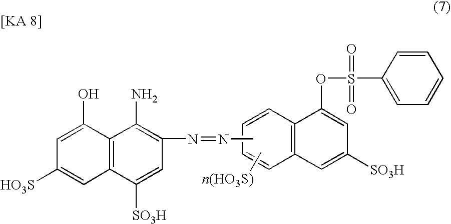

(wherein, n represents the same meaning as in the above Formula (5)).

Apart from this, a compound represented by the following Formula (8) or (9) is diazotized,

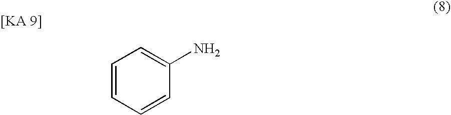

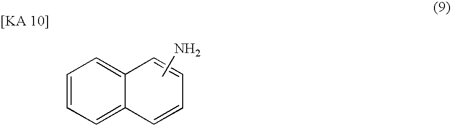

(Wherein, each of a phenyl group and a naphthyl group may independently have substituents. As a substituent, for example, the described ones as a substituent of A or D in Formula (2) can be included. That is, a phenyl group or a naphthyl group in the above Formula is expediently used instead of A or D in Formula (2) to make it clearly understandable. Hereinafter the same in the synthetic reactions described here.) and then the diazotized compound is subjected to coupling reaction with a compound represented by the following Formula (10)

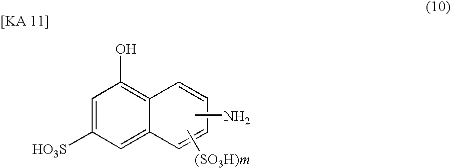

(wherein, m has the same meaning as m′ in Formula (2). Hereinafter the same in the synthetic reactions described here) to obtain a compound represented by the following Formulas (11) or (12).

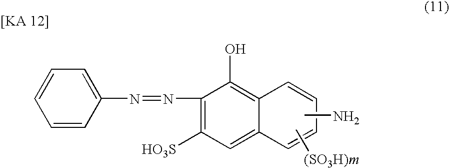

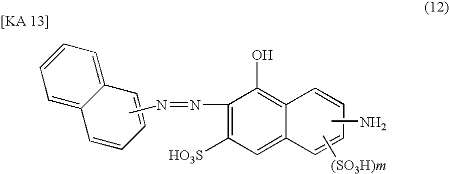

These compounds are further diazotized respectively, and the diazotized compounds are then subjected to coupling reaction respectively with a compound represented by Formula (7) to obtain a compound represented by the following Formula (13) or (14).

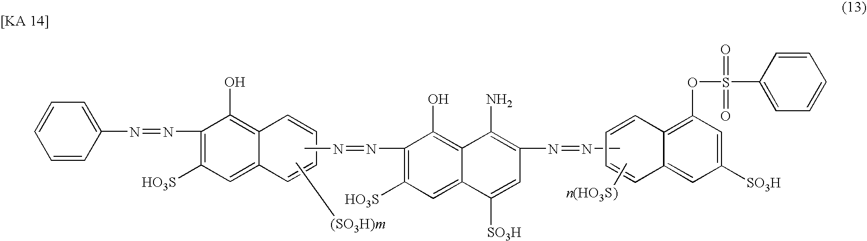

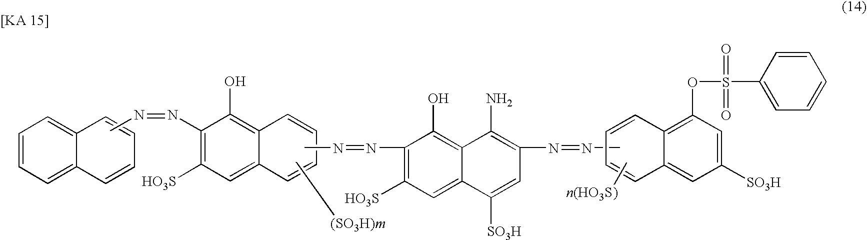

These compounds are treated with alkali respectively to obtain a compound represented by the following Formula (15) or (16).

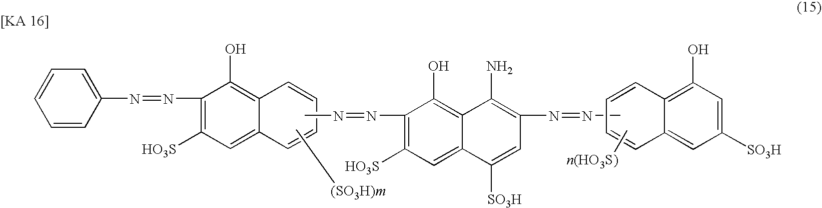

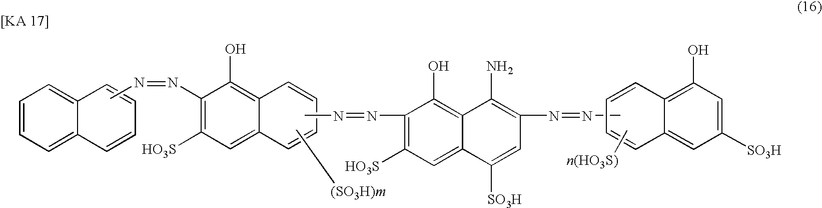

These are subjected to coupling with a diazotized compound of a compound respectively represented by Formula (8) or (9) to obtain a compound represented by the following Formulas (17), (18), (19) or (20)

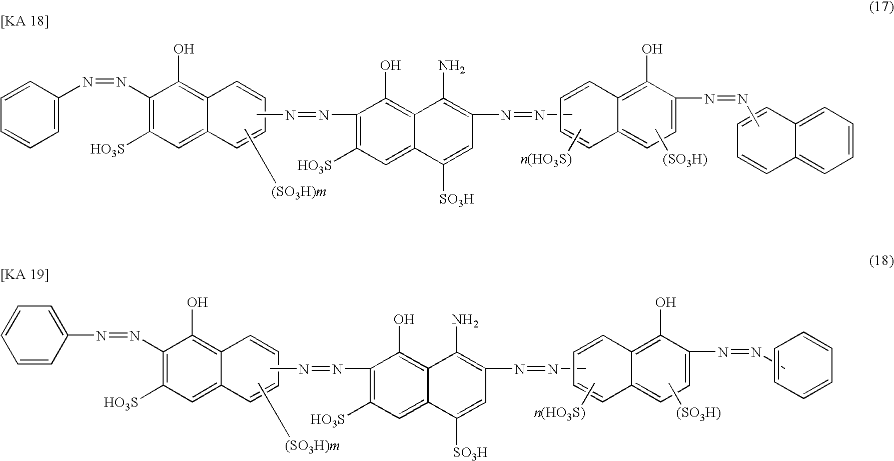

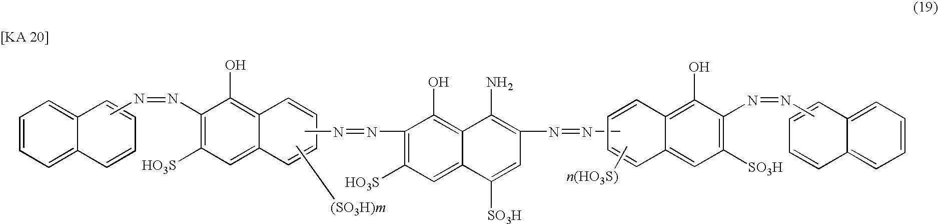

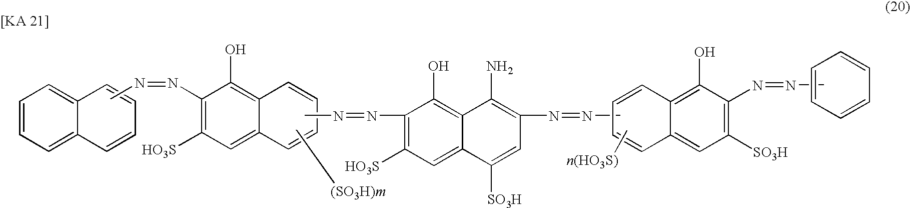

(wherein, m and n represent the same meanings as m′ and n′ in Formula (2), and a phenyl group or a naphthyl group existing at the both ends is the same as A or D in Formula (2)).

Any of these Compounds is Included in Compounds of Formula (2).

Otherwise, a compound represented by Formula (11) or (12) is diazotized, and the diazotized compound is then subjected to coupling reaction with a compound represented by Formula (6) to obtain a compound represented by the following Formula (21) or (22), 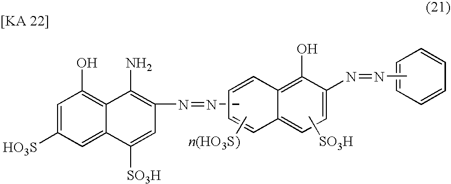 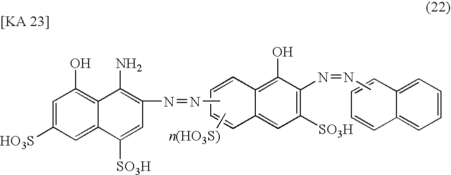
which compound is subjected to coupling with a diazotized compound of a compound represented by Formula (11) or (12) to be also able to obtain a compound represented by the above Formula (17), (18), (19) or (20). These are, as described above, ones included in the tetrakisazo compounds as represented by Formula (2).

The diazotization of a compound of Formulas (8) or (9) is carried out in a known manner per se, for example, in an inorganic acid medium, for example, at a temperature of −5 to 30° C., preferably at 0 to 10° C., using a nitrite salt, for example, an alkali metal nitrite salt such as sodium nitrite. The coupling of a diazotized compound of a compound of Formulas (8) or (9) and a compound of Formula (10) is also carried out under known conditions per se. It is favorable to carry out in an aqueous or aqueous organic medium, for example, at a temperature of −5 to 30° C., preferably at 10 to 25° C., and at the pH value of weakly acidic to alkaline. It is preferably carried out at the pH value of neutral to alkaline, for example, at the pH of 7 to 11. The adjustment of this pH value is carried out by the addition of a base. As a base, for example, an alkali metal hydroxide such as lithium hydroxide and sodium hydroxide, an alkali metal carbonate such as lithium carbonate, sodium carbonate and potassium carbonate, an acetate salt such as sodium acetate, ammonia or organic amine can be used. Compounds of Formula (8), (9) and (10) are used in nearly stoichiometric amounts.

The diazotization of a compound of Formulas (11) or (12) is also carried out in a known manner per se, for example, in an inorganic acid medium, for example, at a temperature of −5 to 30° C., preferably at 0 to 20° C., using a nitrite salt, for example, an alkali metal nitrite such as sodium nitrite. The coupling of a diazotized compound of a compound of Formulas (11) or (12) with a compound of Formula (7) is also carried out under known conditions per se. It is favorable to carry out in an aqueous or aqueous organic medium, for example, at a temperature of −5 to 30° C., preferably at 0 to 10° C., and at the pH value of weakly acidic to weakly alkaline. It is preferably carried out at the pH value of weakly acidic to neutral, for example, at the pH of 3 to 7. A base is used for neutralization of acid produced in the course of reaction, and as a base, for example, an alkali metal hydroxide such as lithium hydroxide and sodium hydroxide, an alkali metal carbonate such as lithium carbonate, sodium carbonate and potassium carbonate, an acetate salt such as sodium acetate, or ammonia or organic amine can be used. Compounds of Formula (11), (12) and (7) are used in nearly stoichiometric amounts.

The coupling of a diazotized compound of a compound of Formula (11) or (12) with a compound of Formula (21) or (22) is also carried out under known conditions per se. It is favorable to carry out in an aqueous or aqueous organic medium, for example, at a temperature of −5 to 30° C., preferably at 10 to 25° C., and at the pH value of weakly acidic to alkaline. It is preferably carried out at the pH value of neutral to alkaline, for example, at the pH of 7 to 11. The adjustment of this pH value is carried out by the addition of a base. As a base, for example, an alkali metal hydroxide such as lithium hydroxide and sodium hydroxide, an alkali metal carbonate such as lithium carbonate, sodium carbonate and potassium carbonate, an acetate salt such as sodium acetate, ammonia or organic amine can be used. Compounds of Formula (11) or (12) and (21) or (22) are used in nearly stoichiometric amounts.

A tetrakisazo compound represented by Formula (1), (1′) or (2) of the present invention or a salt thereof (hereinafter, a compound or a salt thereof are referred to as a compound for simplicity unless otherwise specified), after coupling reaction, can be isolated in the free acid form by the addition of mineral acid, which can be then washed by water or acidified water to eliminate an inorganic salt. The thus obtained acidic-type coloring matter having a low salt content rate can be converted to a corresponding salt solution by neutralization with an optional inorganic or organic base in an aqueous medium. Examples of an inorganic base include, for example, a hydroxide of an alkali metal such as lithium hydroxide, sodium hydroxide and potassium hydroxide, ammonium hydroxide, a carbonate of an alkali metal such as lithium carbonate, sodium carbonate and potassium carbonate, and the like, and examples of an organic base include, for example, an organic amine shown in the above Formula (3) and the like, however not limited thereto. In this connection, it is known that solubility is improved by converting a part or all of the acidic-type coloring matter to a lithium salt using lithium hydroxide or lithium carbonate in general.

A compound of Formula (1) not including in Formula (2) can be also obtained easily in a similar method to the described above for the skilled in the art, by using a material compound respectively corresponding to an objective compound.

A tetrakisazo compound represented by the above Formula (1), (1′) or (2) of the present invention, more preferably a tetrakisazo compound represented by formula (a) is useful as a coloring matter for dyeing materials composed of cellulose, materials having a carbonamide bond and other materials, and a coloring matter for recording of printing and the like.

An aqueous composition containing the tetrakisazo compound can dye materials composed of cellulose. In addition, it can also dye other materials having a carbonamide bond and be widely used for dyeing leather, textile and paper. As a preferable usage of a compound of the present invention, an ink composition produced by dissolving in a liquid medium is included.

Next, an ink composition according to the present invention and an ink for ink-jet printing will be explained.

An Ink Composition and an Ink for Ink-jet Printing

A reaction solution containing a tetrakisazo compound of the present invention described above can be directly used to produce an ink composition for recording. Otherwise, this solution can be first subjected to drying, for example, spray drying to isolate the tetrakisazo compound; or salting out with inorganic salts such as sodium chloride, potassium chloride, calcium chloride and sodium sulfate; aciding out with mineral acid such as hydrochloric acid, sulfuric acid and nitric acid; or aciding-salting out which is a combination of the above described salting-out and aciding-out, to separate a tetrakisazo compound of the present invention, and which can be then processed into an ink composition.

An ink composition according to the present invention is an composition where the main medium is water comprising usually 0.1 to 20 mass %, preferably 1 to 10 mass %, and more preferably 2 to 8 mass % of an tetrakisazo compound of the present invention. An ink composition according to the present invention may further comprise water-soluble organic solvent of, for example, 0 to 30 mass %, and ink preparation agent of, for example, 0 to 5 mass %. Therefore, an ink composition according to the present invention is a water based ink composition usually containing water as the residue besides a tetrakisazo compound of the present invention, the above water-soluble organic solvent and an ink preparation agent. In this connection, the ink composition, on the point of improving storage stability, has preferably the pH of 6 to 10, more preferably the pH of 7 to 10. The ink composition has preferable surface tension of 25 to 70 mN/m, more preferably 25 to 60 mN/m. Furthermore, the ink composition has preferable viscosity of no higher than 30 mPa·s, more preferably no higher than 20 mPa·s.

A water based ink composition according to the present invention is one obtained by dissolving the above tetrakisazo compound of the present invention in water or water-soluble organic solvent (water containing organic solvent or water-miscible organic solvent), if required, followed by the addition of an ink preparation agent. When this ink composition is used as an ink for an ink-jet printer, it is preferable to use a tetrakisazo compound of the present invention containing less inorganic material such as a chloride and a sulfate of metal cation and the like, and the content is, for example, not more than about 1 mass % (based on the coloring matter ingredient) only as a guide. To produce the tetrakisazo compound containing less inorganic material, for example, desalting treatment may be conducted by an ordinary method such as a reverse osmosis method, a method by which a dried material or a wet cake of an azo compound of the present invention is stirred in a mixed solvent of an alcohol such as methanol and water, filtered and dried, and the like.

Specific examples of a water-soluble organic solvent which can be used in preparation of an ink composition according to the present invention include, for example, a (C1 to C4) alkanol such as methanol, ethanol, propanol, isopropanol, butanol, isobutanol, sec-butanol and tert-butanol; a carboxylic acid amide such as N,N-dimethylformamide and N,N-dimethylacetamide; a lactam such as 2-pyrrolidone and N-methylpyrrolidin-2-one; cyclic ureas such as 1,3-dimethylimidazolidin-2-one or 1,3-dimethylhexahydropyrimid-2-one; a ketone or a ketoalcohol such as acetone, methylethylketone and 2-methyl-2-hydroxypentan4-one; a cyclic ether such as tetrahydrofuran and dioxane; a mono-, oligo- or polyalkylene glycol or thio glycol having (C2 to C6) alkylene units such as ethylene glycol, 1,2-propylene glycol, 1,3-propylene glycol, 1,2-butylene glycol, 1,4-butylnene glycol, 1,6-hexylene glycol, diethylene glycol, triethylene glycol, tetraethylene glycol, dipropylene glycol, polyethylene glycol, polypropylene glycol, thio diglycol and dithio diglycol; a polyol (triol) such as glycerin, and hexane-1,2,6-triol; a (C1 to C4) alkyl ether of a polyhydric alcohol such as ethylene glycol monomethyl ether or ethylene glycol monoethyl ether, diethylene glycol monomethyl ether or diethylene glycol monoethyl ether or triethylene glycol monomethyl ether or triethyleneglycol monoethyl ether; gamma-butylolactone; dimethylsulfoxide; and the like. These organic solvents may be used alone or in a combination of two or more kinds thereof.

Examples of an ink preparation agent which can be used in preparation of an ink composition according to the present invention include, for example, an antiseptic and fungicide, a pH modifier, a chelating agent, an antirust agent, a water-soluble ultraviolet absorber, a water-soluble polymer, a dye-dissolving agent, an antioxidant, a surfactant, and the like.

The above antiseptic and fungicide includes a compound of, for example, an organic sulfur base, an organic nitrogen-sulfur base, an organic halogen base, a haloallylsulfone base, an iodopropargyl base, an N-haloalkylthio base, a benzothiazole base, a nitrile base, a pyridine base, an 8-oxyquinoline base, a benzothiazole base, an isothiazoline base, a dithiol base, a pyridineoxide base, a nitropropane base, an organotin base, a phenol base, a quaternary ammonium salt base, a triazine base, a thiazine base, an anilide base, an adamantane base, a dithiocarbamate base, a brominated indanone base, a benzylbromoacetate base and an inorganic salt base. The compound of an organic halogen base includes, for example, sodium pentachlorophenol, the compound of a pyridineoxide base includes, for example, sodium 2-pyridinethiol-1-oxide, the compound of an inorganic salt base includes, for example, anhydrous sodium acetate, and the compound of an isothiazoline base includes, for example, 1,2-benzisothiazolin-3-one, 2-n-octyl-4-isothiazolin-3-one, 5-chloro-2-methyl-4-isothiazolin-3-one, 5-chloro-2-methyl-4-isothiazolin-3-one magnesium chloride, 5-chloro-2-methyl-4-isothiazolin-3-one calcium chloride, 2-methyl-4-isothiazolin-3-one calcium chloride and the like. Other antiseptic and fungicides include sodium sorbate, sodium benzoate, and the like. It is preferable to use 0.02 to 1.00 mass % thereof in an ink composition.

As a pH modifier, any substance can be used as long as it can control the pH of an ink composition in the range of, for example, 5 to 11, without impairing an ink composition to be formulated. Examples of the pH modifier include an alkanolamine such as diethanolamine, triethanolamine and N-methyldiethanolamine; an inorganic base including a hydroxide of an alkali metal such as lithium hydroxide, sodium hydroxide and potassium hydroxide, an ammonium hydroxide (ammonia), a carbonate salt of an alkali metal such as lithium carbonate, sodium carbonate, sodium hydrogencarbonate and potassium carbonate, potassium acetate, sodium silicate and disodium phosphate; and the like.

The chelating agent includes, for example, sodium ethylenediamine tetraacetate, sodium nitrilo triacetate, sodium hydroxyethylethylenediamine triacetate, sodium diethylenetriamine pentaacetate, sodium uracil diacetate and the like.

The antirust agent includes, for example, an acidic sulfite salt, sodium thiosulfate, ammonium thioglycolate, diisopropyl ammonium nitrite, pentaerythritol tetranitrate, dicyclohexyl ammonium nitrite and the like.

The water-soluble ultraviolet absorber includes, for example, a sulfonated benzophenone-based compound, a benzotriazole-based compound, a salicyclic acid-based compound, a cinnamic acid-based compound and a triazine-based compound.

The water-soluble polymer includes polyvinyl alcohol, a cellulose derivative, a polyamine, a polyimine, and the like.

The dye-dissolving agent includes, for example, ε-caprolactam, ethylene carbonate, urea and the like.

As antioxidant, for example, various organic or metal complex-based fading inhibitors can be used. The above organic fading inhibitors include hydroquinones, alkoxyphenols, dialkoxyphenols, phenols, anilines, amines, indans, chromans, alkoxyanilines, heterocycles and the like.

The surfactant includes known surfactants such as an anionic, cationic, ampholytic and nonionic surfactant. The anionic surfactant includes an alkyl sulfonic acid, alkyl carboxylate, α-olefin sulfonate, polyoxyethylene alkyl ether acetate, N-acylamino acid and a salt thereof, N-acylmethyltaurine salt, alkyl sulfate-polyoxyalkyl ether sulfate, alkyl sulfate-polyoxyethylenealkyl ether phosphate, rosin acid soap, caster oil sulfate, lauryl alcohol sulfate, alkylphenol-type phosphate, alkyl-type phosphate, alkylallyl sulfonate, diethylsulfo succinate, diethylhexylsulfo succinate, dioctylsulfo succinate and the like. The cationic surfactant includes a 2-vinylpyridine derivative, a poly 4-vinylpyridine derivative and the like. The ampholytic surfactant includes lauryldimethylamino acetic acid betaine, 2-alkyl-N-carboxymethyl-N-hydroxyethylimidazolinium betaine, coconut oil fatty acid amide propyldimethylamino acetic acid betaine, polyoctylpolyaminoethylglycine, an imidazoline derivative, and the like. The nonionic surfactant includes ethers such as polyoxyethylene nonyl phenyl ether, polyoxyethylene octyl phenyl ether, polyoxyethylene dodecyl phenyl ether, polyoxyethylene oleyl ether, polyoxyethylene lauryl ether and polyoxyethylene alkyl ether; esters such as polyoxyethylene oleic acid, polyoxyethylene oleate, polyoxyethylene distearate, sorbitan laurate, sorbitan monostearate, sorbitan monooleate, sorbitan sesquiorate, polyoxyethylene monooleate and polyoxyethylene stearate; and acetylene glycols such as 2,4,7,9-tetramethyl-5-decyne-4,7-diol, 3,6-dimethyl-4-octyne-3,6-diol and 3,5-dimethyl-1-hexyne-3-ol (for example, Surfynol 104, 105, 82, 465, and Olfine STG from Nissin Chemical Industry Co., Ltd.). These ink preparation agents are used alone or in mixture thereof.

An ink composition according to the present invention is obtained by mixing and stirring the above each ingredient in arbitrary order. The obtained ink composition may be filtered with a membrane filter or the like to remove impurities. For fine adjustment of black tones, other coloring matter having various hues may be mixed. In that case, besides a tetrakisazo compound of the present invention, coloring matter of yellow, magenta, cyan and other hues can be used.

An ink composition of the present invention can be used in various fields, and is suitable for a water-based ink for writing, a water-based printing ink, an information recording ink, and the like, particularly preferably for an ink for ink-jet printing containing the ink composition. Therefore, an ink for ink-jet printing of the present invention is characterized by comprising an ink composition of the present invention, and ink for ink-jet printing according to the present invention is suitably used in an ink-jet recording method of the present invention described later.

Method for Ink-jet Recording

A method for ink-jet recording of the present invention will be explained. A method for ink-jet recording of the present invention is characterized by recording using an ink for ink-jet recording comprising the above ink composition. In the method for ink-jet recoding of the present invention, recording is conducted on image receiving materials using an ink for ink-jet recording comprising the above ink composition, and an ink nozzle and the like to be used in this occasion are not especially limited and can be selected as appropriate according to the purpose.

The above image receiving materials, not especially limited, include known record-receiving materials such as a plain paper, a resin-coated paper, a professional paper for ink-jet, a film, a plain paper for electrophotography, cloth, glass, metal and ceramics.

In the ink-jet recording method for the present invention, among the above image receiving materials, the following recording paper and recording film called, for example, professional paper for ink-jet, professional glossy paper for ink-jet, and professional film for ink-jet are particularly preferably used.

In the above recording paper and recording film, an image receiving layer are laminated on a support substrate and other layers such as a back coat layer may be also laminated as needed. Each layer such as the image receiving layer may be a single layer or multiple layers.

The above support substrate is composed of chemical pulp such as LBKP and NBKP, mechanical pulp such as GP, PGW, RMP, TMP, CTMP, CMP and CGP and waste paper pulp such as DIP, and one produced by various machines such as a Fourdrinier paper machine and a cylinder paper machine after adding and mixing as needed with a known pigment, a binder, a sizing agent, a fixing agent, a cation agent, a paper reinforcing agent, and the like may also be used as well as synthetic paper and plastic film sheet.

The above support substrate preferably has thickness of about 10 to 250 μm and basis weight of 10 to 250 g/m².

The above support substrate may be provided with the above image receiving layer directly or with the above back coat layer and then with the image receiving layer on the back coat, or provided with the above recording layer and the above back coat layer after being provided with a size press layer or an anchor layer of starch or polyvinyl alcohol and etc. The above support substrate may also be subjected to flattening treatment by a calender such as a machine calender, a TG calender and a soft calender.

Among the above support substrates, a paper laminated with polyolefine (for example, polyethylene, polystyrene, polyethylene terephthalate, polybutene and a copolymer thereof, and the like) on both sides and a plastic film are preferably used.

The above recording layer may contain a pigment, a water-based binder, a mordant, a water proofing agent, a light fastness improving agent, a surfactant and other additives.

The above pigment is preferably a white pigment, and the white pigment includes, preferably for example, an inorganic white pigment such as calcium carbonate, kaolin, talc, clay, diatom earth, synthetic amorphous silica, aluminum silicate, magnesium silicate, calcium silicate, aluminum hydroxide, alumina, lithopone, zeolite, barium sulfate, calcium sulfate, titanium dioxide, zinc sulfide and zinc carbonate, and an organic pigment such as a styrene-based pigment, an acrylic-based pigment, a urea resin and a melamine resin. Among these white pigments, a porous inorganic pigment is preferable.

The above water-based binder includes, for example, a water-soluble polymer such as polyvinyl alcohol, silanol-modified polyvinyl alcohol, starch, cationized starch, casein, gelatin, carboxymethyl cellulose, hydroxyethyl cellulose, polyvinyl pyrrolidone, polyalkylene oxide and a polyalkylene oxide derivative; a water-dispersible polymer such as styrene-butadiene latex and acrylic emulsion; and the like. These water-based binders may be used alone or in combination of two or more kinds.

As the above mordant, a polymer mordant is preferably used.

The above water proofing agent is effective for improving water fastness of an image and suitably includes a cationic resin. The above cationic resin includes, for example, polyamide polyamine epichlorohydrin, polyethylene imine, polyamine sulfone, dimethyldiallylammonium chloride polymer, cationic polyacrylamide and colloidal silica and the like.

The above light fastness improving agent includes, for example, zinc sulfate, zinc oxide, a hindered amine-based antioxidant and a benzophenone-based or benzotriazole-based ultraviolet absorber and the like.

The above surfactant functions as an auxiliary agent for coating, a peel improving agent, a slip improving agent or an antistatic agent. Instead of the above surfactant, an organofluoro compound may be used. The above organofluoro compound includes, for example, a fluorine-containing surfactant, an oily fluoro compound (for example, fluorine oil) and a solid fluoro compound resin (for example, tetrafluoroethylene resin and the like).

The above other additives include, for example, a pigment dispersing agent, a thickening agent, an antifoaming agent, a dye, a fluorescent whitening agent, an antiseptic, a pH modifier, a matting agent, a film-hardener and the like.

The above back coat layer may contain a white pigment, a water-based binder and other ingredients.

The above white pigment includes, for example, an inorganic white pigment such as light calcium carbonate, heavy calcium carbonate, kaolin, talc, calcium sulfate, barium sulfate, titanium dioxide, zinc oxide, zinc sulfide, zinc carbonate, satin white, aluminum silicate, diatomaceous earth, calcium silicate, magnesium silicate, synthetic amorphous silica, colloidal silica, colloidal alumina, pseudboehmite, aluminum hydroxide, alumina, lithopone, zeolite, aqueous halloysite, magnesium carbonate and magnesium hydroxide, and an organic pigment such as a styrene-based plastic pigment, an acrylic-based plastic pigment, polyethylene, a microcapsule, a urea resin, a melamine resin and the like.

The above water-based binder includes a water-soluble polymer such as a styrene/maleate copolymer, a styrene/acrylate copolymer, polyvinyl alcohol, silanol-modified polyvinyl alcohol, starch, cationized starch, casein, gelatin, carboxymethyl cellulose, hydroxyethyl cellulose, polyvinyl pyrrolidone, and a water-dispersible polymer such as styrene-butadiene latex and acrylic emulsion and the like.

The above other ingredients include an antifoaming agent, a foam inhibitor, a dye, a fluorescent whitening agent, an antiseptic, a water proofing agent, and the like.

Composed layers (including a back coat layer) in the above recording paper and recording film may be added with polymer latex. The above polymer latex is used for the purpose of improving film physical properties such as stabilizing dimension, preventing curling, preventing adherence and preventing film cracking. By the addition of polymer latex having low glass transition temperature (not higher than 40° C.) to a layer containing the above mordant, cracking and curling of the layer can be prevented. Also by the addition of polymer latex having high glass transition temperature to the above back coat layer, curling of the layer can be prevented.

An ink-jet recording method of the present invention is not especially limited and may include any known method such as an electric charge controlling method to discharge ink utilizing static induction force, a drop-on-demand method (pressure pulse method) to make use of vibration pressure of piezoelectric elements, an acoustic ink-jet method to discharge ink by radiation pressure according to radiation to ink of acoustic beams converted from electric signals, and a thermal ink-jet method (Bubble Jet (registered trademark)) to make use of pressure of bubbles generated by heating ink. The above ink-jet recording method also includes a method for injecting a number of tiny droplets having a low concentration ink called a photo ink, a method for improving image quality using multiple inks having substantially the same hue and different concentration, and a method for using a colorless and transparent ink.

The tetrakisazo compound of the present invention is excellent in water solubility, and an ink composition of the present invention comprising a tetrakisazo compound doesn't exhibit crystal deposition, change of physical properties, color change and the like after storage for a long period of time and has good storage stability. In addition, a black ink liquid for recording comprising a tetrakisazo compound of the present invention is used for ink-jet recording and writing tools, and when a recording image is made on a plain paper and a professional paper for ink-jet, the hue of a recorded image is neutral and printing density of black is high, and further it is excellent in ozone fastness, light fastness, moisture fastness, and color rendering properties.

Hereinafter, the present invention is more specifically explained by Examples, but the present invention should not be limited thereto. In this connection, “part” and “%” in the specification are based on mass unless otherwise specified. Compounds are represented in the free acid form.

### EXAMPLE 1

(The first process) Into 200 parts of water, 17.3 parts of 2-aminobenzenesulfonic acid was charged and neutralized with sodium hydroxide to dissolve, followed by adding 31.3 parts of 35% hydrochloric acid, adjusting the temperature thereof at 5° C. or lower, and diazotizing with 18.1 part of 40% aqueous solution of sodium nitrite to obtain a diazo suspension. Subsequently, 23.9 parts of 7-amino-4-hydroxynaphthalene-2-sulfonic acid (J Acid) was dispersed in 200 parts of water and dissolved adjusting the pH value to 8.0 to 9.0 with sodium hydroxide, and into the obtained solution, the above obtained diazo suspension was added dropwise at 5 to 10° C. During the dropwise addition, the pH value of the reaction solution was maintained at 8.5 to 9.5 with sodium carbonate. After the completion of the dropwise addition, furthermore, the pH value was adjusted at 8.5 to 9.5 with sodium carbonate, stirring was conducted at a temperature of 10 to 15° C. for 2 hours, and the coupling reaction was completed, followed by salting out by the addition of sodium chloride, and filtering. The thus obtained wet cake was dried to obtain 36.3 parts of a monoazo compound of Formula (23).

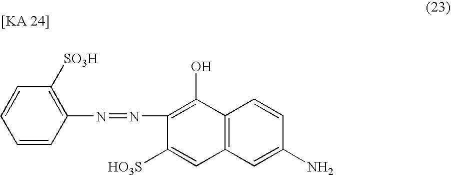

(The second process) After 47.3 parts of a compound of the following Formula (24) was dissolved in 400 parts of water by adjusting the pH at 6.0 to 8.0 with sodium hydroxide, the solution was cooled at 5° C. or lower, and 41.7 parts of 35% hydrochloric acid was added thereto. To the obtained solution, 18.1 parts of 40% aqueous solution of sodium nitrite was added and diazotization was carried out at 10° C. or lower.

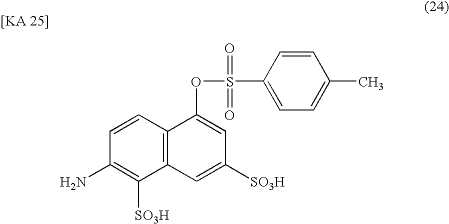

Subsequently, 31.9 parts of 4-amino-5-hydroxynaphthalene-1,7-disulfonic acid (K Acid) was added in the thus obtained diazo suspension. After the addition, stirring was conducted at 10 to 15° C. for 6 hours while adjusting the pH value to 2.0 to 3.0 with a 10% aqueous solution of sodium carbonate to obtain a reaction solution containing a compound of the following Formula (25).

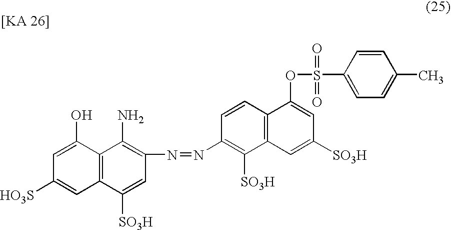

(The third process) The pH was adjusted to 7.0 to 8.0 with sodium hydroxide to dissolve 36.3 parts of the compound of Formula (23) obtained in the first process, and then, 16.3 parts of 40% aqueous solution of sodium nitrite was added thereto. Subsequently, this obtained solution was added to 320 parts of 5% hydrochloric acid at 15 to 20° C. for diazotization. The obtained diazo suspension was added dropwise to the reaction solution containing the compound of Formula (25) obtained in the second process at 15 to 25° C. During the dropwise addition, the pH value of the reaction solution was maintained at 8.0 to 9.5 with sodium carbonate. After the completion of the dropwise addition, further, stirring was conducted at 15 to 25° C. for 3 hours at the pH of 8.0 to 9.0 to complete coupling reaction, followed by salting out by the addition of sodium chloride, and filtering to obtain 320 parts of a wet cake of a compound of the following Formula (26).

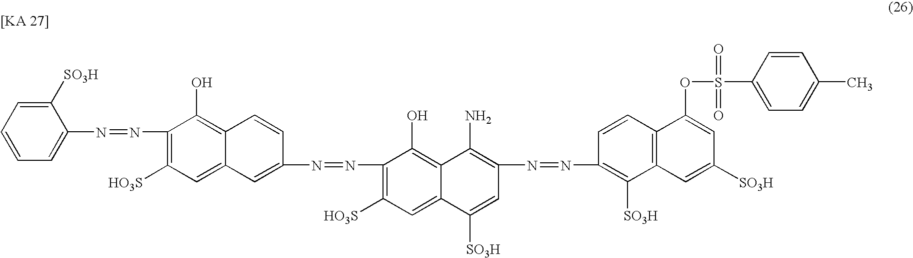

(The fourth process) The whole amount of the wet cake of the compound of Formula (26) obtained in the third process was dissolved in 900 parts of water, then heated to 70 to 75° C. and treated at the same temperature at the pH value of 10.5 to 11.0 for 2 hours to obtain a reaction solution containing a compound of the following Formula (27).

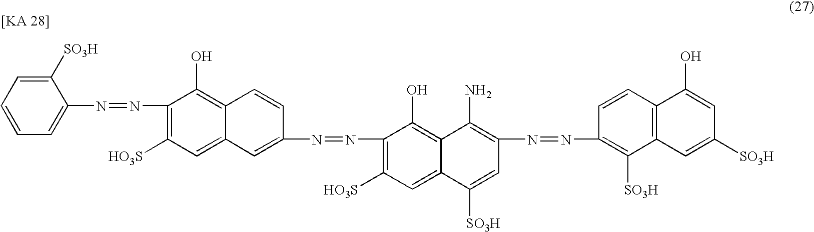

(The fifth process) In 200 parts of water, 20.3 parts of 2-amino-5-methoxybenzenesulfonic acid was dispersed and 31.3 parts of 35% hydrochloric acid was added, and then the resultant mixture was cooled to 5 to 10° C. At the same temperature, 18.1 parts of 40% aqueous solution of sodium nitrite was added thereto for diazotization. Subsequently, after the thus obtained diazo suspension was added at 15 to 20° C. into the reaction solution containing the compound of Formula (27) obtained in the forth process, the pH value was gradually neutralized to 7.5 to 9.0 with sodium carbonate. After the neutralization, stirring was conducted at 15 to 25° C. at the pH of 8.0 to 9.0 for 3 hours and the coupling reaction was completed to obtain a reaction solution containing a compound of Formula (28). After that, salting out was conducted by the addition of sodium chloride, and the obtained precipitates were filtered and then dried to obtain 83.0 parts of tetrakisazo compound of Formula (28).

(Desalination process) After 83.0 parts of the compound of Formula (28) obtained in the fifth process was dissolved in 800 parts of water, 900 parts of methanol was added, and the deposited coloring matter was filtered and then dried to obtain 66.4 parts of desalted black coloring matter of Formula (28) (a compound No. 1 in Table 1: Na salt). The maximum absorption wavelength (λ max) of this coloring matter in water was 619 nm, and solubility test in water (ammonia alkali) by filter paper spot was no less than 100 g/l.

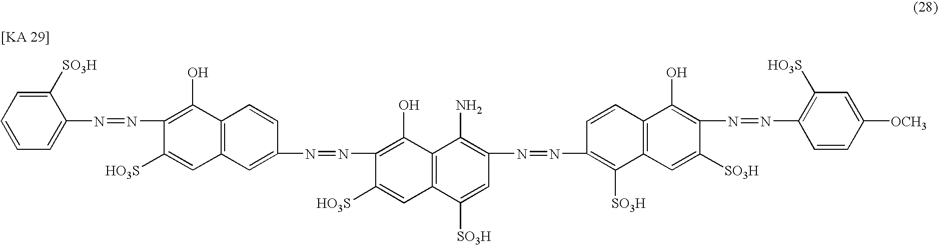

### EXAMPLE 2

In the same manner as in Example 1 except that 47.3 parts of a compound of Formula (29) was used instead of 47.3 parts of a compound of Formula (24) in the second process of Example 1, 71.2 parts of black coloring matter of Formula (30) (a compound No.2 in Table 1: Na salt) was obtained. The maximum absorption wavelength (λ max) of this coloring matter in water was 632 nm, and solubility test in water (ammonia alkali) by filter paper spot was no less than 100 g/l.

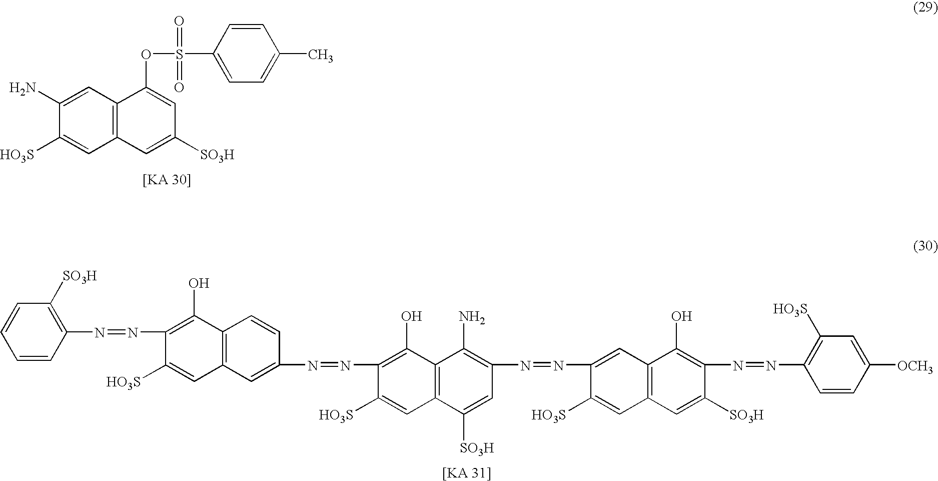

### EXAMPLE 3

(The first process) In the same manner except that the scale of the second process in Example 1 was doubled, 94.6 parts of a compound of Formula (24) was diazotized, and then half amount of the obtained diazo suspension was reacted with 31.9 parts of 4-amino-5-hydroxy-1,7-disulfonic acid to obtain Formula (25). Thereafter, the reaction solution was neutralized to the pH value of 6.5 to 7.5 with sodium carbonate. Subsequently, the rest half of the diazo suspension of Formula (24) synthesized in advance was added dropwise in the neutral solution containing a compound of the above Formula (25), at 10 to 15° C. at the pH value of 7.0 to 8.0. After the dropwise addition, stirring was conducted at the same temperature at the same pH value for two hours and a disazo compound of the following Formula (31) was obtained.

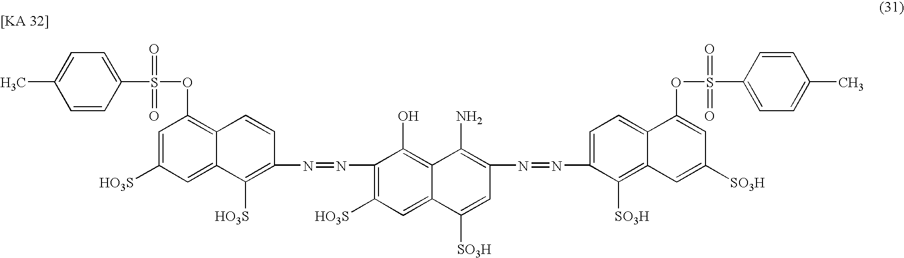

Subsequently, the reaction solution containing the above disazo compound was heated to 70 to 75° C., then treated for 2 hours while maintaining the pH value to 10.0 to 11.0 with sodium hydroxide, and thereafter neutralized to the pH value of 7.0, and salting out was conducted by the addition sodium chloride. The precipitated sediment was filtered and dried to obtain 73.4 parts of a disazo compound of the following Formula (32).

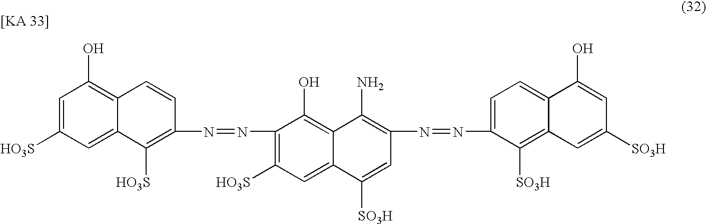

(The second process) In 340 parts of 50° C. warm water, 38.4 parts of sodium 2-amino-5-nitrobenzenesulfonate was dissolved and then 50.5 parts of 35% hydrochloric acid was added thereto. The obtained solution was cooled to 5 to 10° C. by the addition of ice. Subsequently, 29.0 parts of 40% sodium nitrite was added thereto at the same temperature for diazotization. The obtained diazo suspension was added at 15 to 20° C. to a reaction solution where 73.4 parts of a compound of the above Formula (32) was dissolved in 1000 parts of water, and then the pH value was gradually neutralized to 6.0 to 7.0 with sodium carbonate. After the neutralization, further, stirring was conducted at 15 to 20° C. at the pH of 7.0 to 8.0 for 3 hours and the coupling reaction was completed, and then salting out was conducted by the addition of sodium chloride. Thereafter, 430 part of wet cake of a tetrakisazo compound of the following Formula (33) was obtained by filtration.

(Desalination process) The whole amount of the wet cake of the compound of Formula (33) obtained in the second process was dissolved in 800 parts of water, and then 1000 parts of methanol was added thereto. The deposited coloring matter was filtered and dried to obtain 68.2 parts of desalted black coloring matter of Formula (33) (a compound No. 16 in Table 2: Na salt). The maximum absorption wavelength (λ max) of this coloring matter in water was 608 nm, and solubility test in water (ammonia alkali) by filter paper spot was no less than 100 g/l.

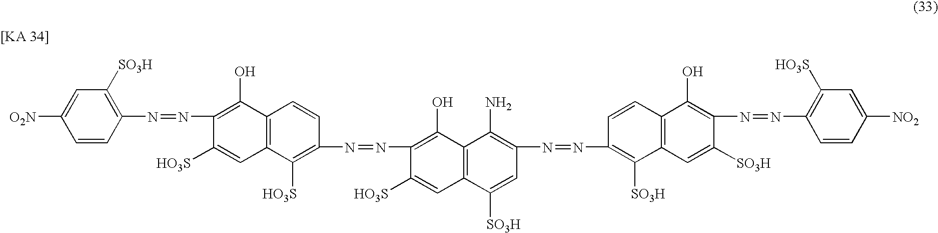

### EXAMPLE 4

In the same manner as in Example 3 except that 29.7 parts of 2-amino-5-methoxybenzenesulfonic acid was used instead of 38.4 parts of 2-amino-5-nitrobenzenesulfonic acid in the second process of Example 3, 78.7 parts of black coloring matter of the following Formula (34) (a compound No. 19 in Table 2: Na salt) was obtained. The maximum absorption wavelength (λ max) of this coloring matter in water was 612 nm, and solubility test in water (ammonia alkali) by filter paper spot was no less than 100 g/l.

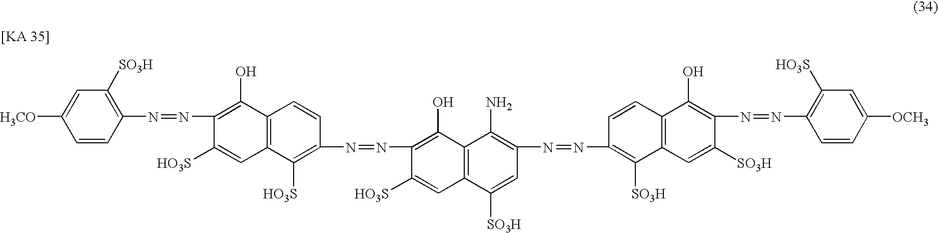

### EXAMPLE 5

In the same manner as in Example 3 except that 29.0 parts of 5-aminoisophthalic acid was used instead of 38.4 parts of 2-amino-5-nitrobenzenesulfonic acid in the second process of Example 3, 75.0 parts 10 of black coloring matter of Formula (35) (a compound No. 17 in Table 2: Na salt) was obtained. The maximum absorption wavelength (λ max) of this coloring matter in water was 604 nm, and solubility test in water (ammonia alkali) by filter paper spot was no less than 100 g/l.

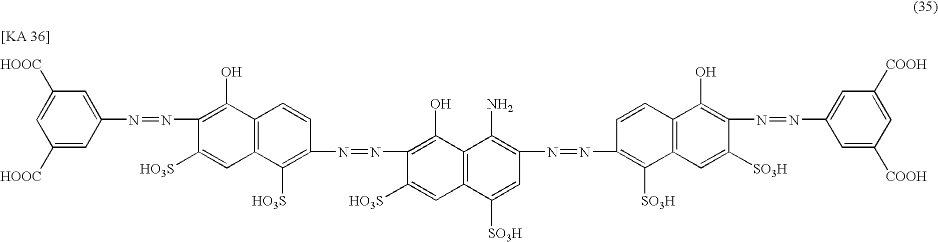

### EXAMPLE 6

In the same manner as in Example 3 except that 55.7 parts of 3-amino-7-nitronaphthalene-1,5-disulfonic acid was used instead of 38.4 parts of 2-amino-5-nitrobenzenesulfonic acid in the second process of Example 3, 68.5 parts of black coloring matter of the following Formula (36) (a compound No. 28 in Table 3: Na salt) was obtained. The maximum absorption wavelength (λ max) of this coloring matter in water was 610 nm, and solubility test in water (ammonia alkali) by filter paper spot was no less than 100 g/l.

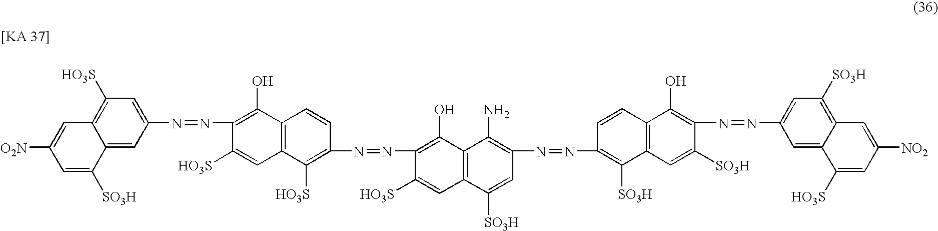

### EXAMPLE 7

(The first process) In 200 parts of water, 37.8 parts of a compound of Formula (29) was dissolved by adjusting the pH at 5.5 to 8.0 with sodium hydroxide, 29.2 parts of 35% hydrochloric acid was added thereto, and the solution was cooled at 5° C. or lower by the addition of ice, followed by quickly adding 14.1 parts of 40% an aqueous solution of sodium nitrite for diazotization. Subsequently, 25.5 parts of 8-amino-1-hydroxynaphthalene-3,5-disulfonic acid (K Acid) was added to the obtained diazo suspension, and then stirring was conducted at 10 to 15° C. for 6 hours, while adjusting the pH value to 2.0 to 3.0 with sodium carbonate, to obtain a reaction solution containing a compound of the following Formula (37).

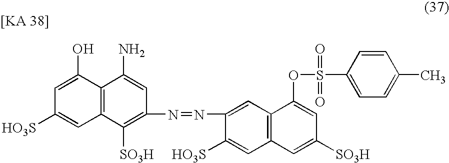

(The second process) In 200 parts of water, 37.8 parts of a compound of Formula (24) was dissolved by adjusting the pH to 5.5 to 8.0 with sodium hydroxide, 29.2 parts of 35% hydrochloric acid was added thereto, and the solution was cooled at 5° C. or lower by the addition of ice, followed by adding 14.1 parts of 40% aqueous solution of sodium nitrite for diazotization. Subsequently, the obtained diazo suspension was added dropwise to the neutral solution containing the compound of Formula (37) synthesized in advance, at 10 to 15° C. at pH value of 7.0 to 8.0. After the dropwise addition, stirring was conducted at the same temperature at the same pH value for 2 hours to obtain a disazo compound of the following Formula (38).

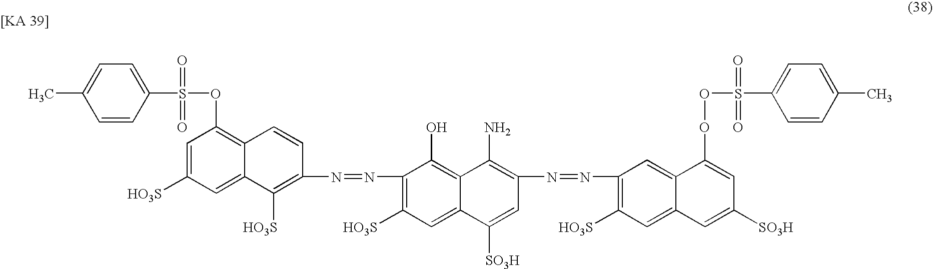

Subsequently, the reaction solution containing the above disazo compound was heated to 70 to 75° C. and treated for 2 hours while maintaining the pH value to 10.0 to 11.0 with sodium hydroxide, followed by neutralizing with 35% hydrochloric acid. Salting out was then conducted by the addition of sodium chloride. The precipitated cake was filtered and dried to obtain 37.0 parts of a disazo compound of the following Formula (39).

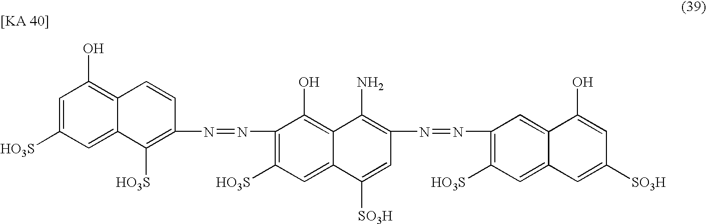

(The third process) In 340 parts of 50° C. warm water, 27.3 parts of 2-amino-5-nitrobenzenesulfonic acid was dissolved, 35.6 parts of 35% hydrochloric acid was added thereto, and the resultant solution was then cooled to 5 to 10° C., followed by adding 20.6 parts of 40% aqueous solution of sodium nitrite at the same temperature for diazotization.

Then the thus obtained diazo suspension was added to a solution dissolving 37.0 parts of the compound of Formula (39) in 1000 parts of water, at 15 to 20° C., and thereafter the pH value was gradually neutralized at 6.0 to 7.0 with sodium carbonate. After the neutralization, further, stirring was conducted at 15 to 20° C. at pH of 7.0 to 8.0 for 3 hours and the coupling reaction was completed to obtain a reaction solution containing a compound of the following Formula (40). After that, salting out was conducted by the addition of sodium chloride and 300 parts of wet cake of a tetrakisazo compound of Formula (40) was obtained by filtration.

(Desalination process) The wet cake obtained in the third process was dissolved under neutral conditions in 600 parts of water, and then 900 parts of methanol was added thereto. The depositing coloring matter was filtered and dried to obtain 57.5 parts of black coloring matter of Formula (40) (a compound No. 13 in Table 2: Na salt). The maximum absorption wavelength (λ max) of this coloring matter in water was 619 nm, and solubility test in water (ammonia alkali) by filter paper spot was no less than 100 g/l.

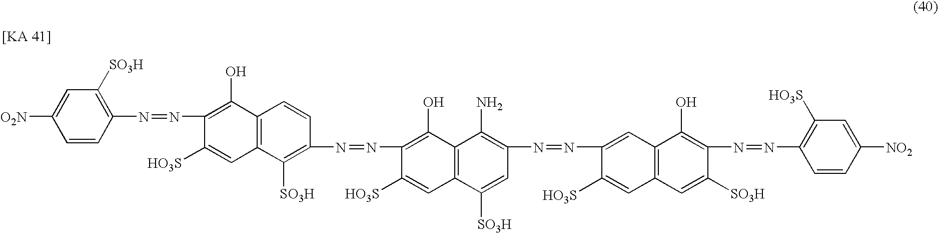

### EXAMPLE 8

(The first process) In 200 parts of water, 20.3 parts of 2-amino-5-methoxybenzenesulfonic acid was dispersed and 31.3 parts of 35% hydrochloric acid was added thereto. The resultant dispersion was then cooled to 5 to 10° C., and at the same temperature 18.1 parts of 40% aqueous solution of sodium nitrite was added thereto for diazotization. The obtained diazo suspension was added dropwise to an alkaline aqueous solution dissolving 23.9 part of 6-amino-4-hydroxynaphthalene-2-sulfonic acid (Gamma Acid) in 230 parts of water at 5 to 10° C. During the dropwise addition, the pH value of the reaction solution was maintained at 8.5 to 9.5 with sodium carbonate. After the completion of the dropwise addition, further, stirring was conducted at pH of 8.5 to 9.5 at a temperature of 10 to 15° C. for 3 hours and the coupling reaction was completed, and thereafter salting out by the addition of sodium chloride and filtering were carried out. The thus obtained wet cake was dried to obtain 36.3 parts of a monoazo compound of the following formula (41).

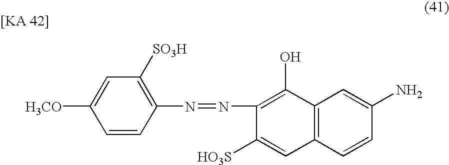

(The second process) In 500 parts of water, 36.3 parts of a compound of Formula (41) was charged and dissolved by adjusting the pH at 5.5 to 8.0 with sodium hydroxide and then 33.4 parts of 35% hydrochloric acid was added thereto. To the resultant solution 16.5 part of 40% aqueous solution of sodium nitrite was added at 15 to 20° C. for diazotization. To the obtained diazo suspension 25.5 parts of 4-amino-5-hydroxynaphtalene-1,7-disulfonic acid (K Acid) was added. After the addition, stirring was conducted over night at 15 to 25° C. while adjusting the pH value to 2.0 to 3.0 with sodium carbonate to obtain a reaction solution containing a compound of the following Formula (42).

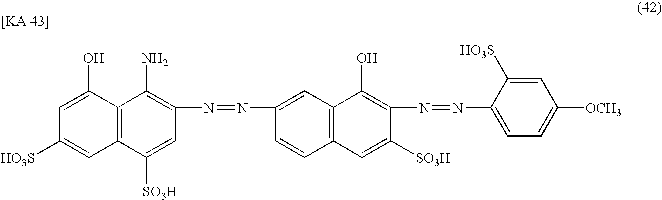

(The third process) A compound of Formula (43) was synthesized in the same manner as in synthesizing the compound of Formula (35) except that 23.9 parts of 7-amino-4-hydroxynaphthalene-2-sulfonic acid (J Acid) was used instead of Gamma Acid in the first process, and 35.3 parts of the obtained compound was dissolved in 250 parts of water, while adjusting the pH at 5.5 to 8.0 with sodium hydroxide. And then, 32.1 parts of 35% hydrochloride acid and 16.2 parts of 40% aqueous solution of sodium nitrite were added thereto for diazotization.

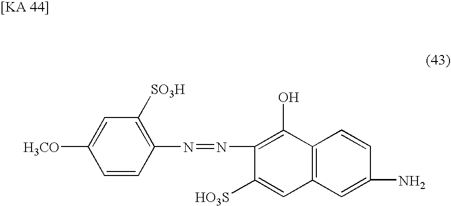

The thus obtained diazo suspension was added dropwise to an alkaline aqueous solution of the compound of Formula (42) obtained in the second process, at 15 to 20° C. During the dropwise addition, the pH value of the solution was maintained at 8.5 to 9.5 with sodium carbonate. After the completion of the dropwise addition, further, stirring was conducted at 15 to 30° C. at the pH of 8.5 to 9.5 for 3 hours and the coupling reaction was completed to obtain a reaction solution containing a compound of the following Formula (44). The pH value was adjusted to 4.0 to 5.0 with 35% hydrochloric acid and then an insoluble portion was eliminated by filtration, and thereafter salting out by the addition of sodium chloride and filtrating were carried out. The whole amount of the obtained cake was dissolved in 500 parts of water, and 500 parts of methanol was added thereto for crystallization and a desalinated wet cake was obtained by filtration and dried to obtain 77.8 parts of black coloring matter of Formula (44) of the present invention (a compound No. 21 in Table 3: Na salt). The maximum absorption wavelength (λ max) of this coloring matter in water was 620 nm, and solubility test in water (ammonia alkali) by filter paper spot was no less than 100 g/l.

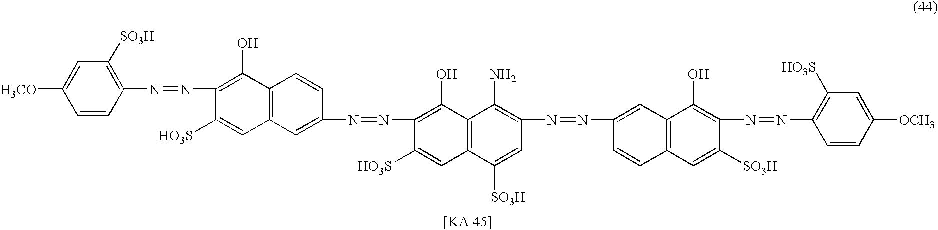

### EXAMPLE 9

(The first process) In 200 parts of water, 39.3 parts of a compound of the following Formula (45) was dissolved by neutralization with sodium hydroxide, and then 18.1 parts of 40% aqueous solution of sodium nitrite was added thereto. This solution was added in 300 part of 5% hydrochloric acid at 15 to 20° C. for diazotization.

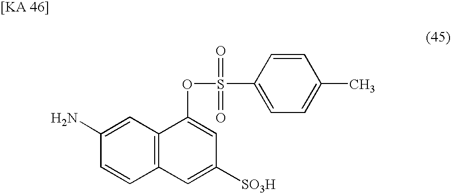

Subsequently, 31.9 part of 4-amino-5-hydroxynaphthalene-1,7-disulfonic acid (K Acid) was added to the thus obtained diazo suspension. After the addition, stirring was conducted at 10 to 15° C. for 12 hours while adjusting the pH value to 2.5 to 3.5 with sodium carbonate to obtain a reaction solution containing a compound of the following Formula (46).

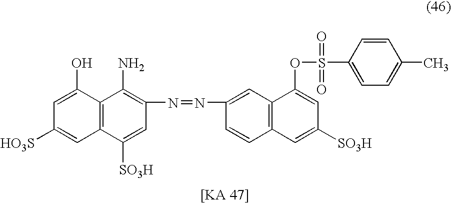

(The second process) In 200 parts of water 47.3 parts of a compound of Formula (24) was dissolved by adjusting the pH at 5.5 to 8.0 with sodium hydroxide, then the solution was cooled at 5° C. or lower and 41.7 part of 35% hydrochloric acid was added thereto, and thereafter to the resultant solution 18.1 parts of 40% aqueous solution of sodium nitrite was added for diazotization. Subsequently, the obtained diazo suspension was added dropwise to a reaction solution containing the compound of Formula (46) obtained above, at 15 to 25° C. During the dropwise addition, the pH value of the solution was maintained at 8.0 to 9.5 with sodium carbonate. After the completion of the dropwise addition, further, stirring was conducted at 15 to 25° C. at the pH of 8.0 to 9.5 for 3 hours and the coupling reaction was completed to obtain a reaction solution containing a compound of the following Formula (47). Subsequently, salting out was conducted by the addition of sodium chloride, followed by filtering to obtain 320 parts of wet cake of a compound of Formula (47).

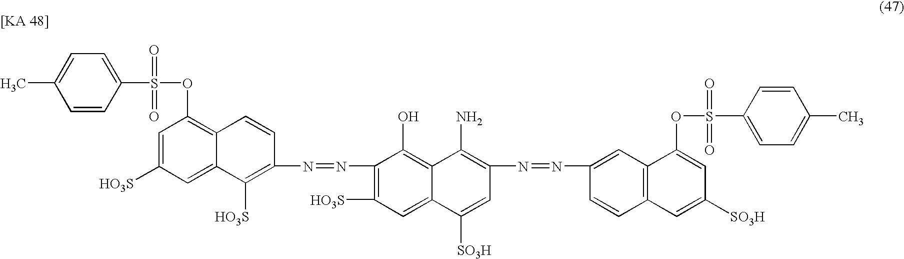

(The third process) In a continuing series, the reaction solution containing the above disazo compound was heated to 70 to 75° C. and treated for 2 hours while maintaining the pH value to 10.0 to 11.0 with sodium hydroxide. Subsequently, after the solution was neutralized at the pH value of 7.0 with hydrochloric acid, salting out was conducted by the addition of the sodium chloride, and the precipitated cake was filtered and dried to obtain 73.4 parts of a disazo compound of Formula (48).

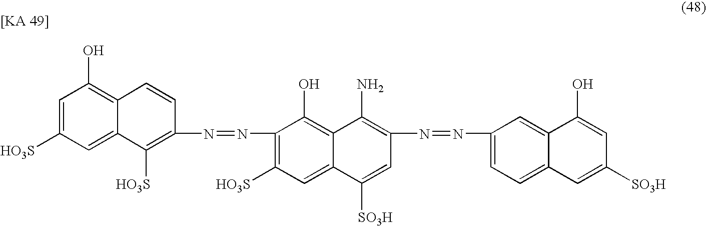

(The forth process) In 350 parts of warm water 38.4 parts of sodium 2-amino-5-nitrobenzenesulfonate was dissolved, and to the obtained solution 50.5 parts of 35% hydrochloric acid was added. The resultant solution was cooled to 5° C. by the addition of ice, and 29.0 parts of 40% aqueous solution of sodium nitrite was added thereto at the same temperature for diazotization. Then the obtained diazo suspension was added at 15 to 20° C. to a reaction solution dissolving 73.4 parts of a compound of Formula (48) in 1000 parts of water and the pH value was gradually neutralized at 6.0 to 7.0 with sodium carbonate. After the neutralization, further, stirring was conducted at 15 to 20° C. at the pH of 7.0 to 8.0 for 3 hours to complete the coupling reaction and a reaction solution containing a compound of the following Formula (49) was obtained. After that, salting out by the addition of sodium chloride and filtration were conducted to obtain 430 parts of a wet cake of a tetrakisazo compound of the following Formula (49).

(Desalination process) The wet cake of a compound of Formula (49) obtained in the second process was dissolved in 800 parts of water, then crystallized by the addition of 1000 parts of methanol thereto and filtered to desalt, followed by drying to obtain 86.2 parts of black coloring matter of Formula (49) (a compound No. 6 in Table 1: Na salt). The maximum absorption wavelength (λ max) of this coloring matter in water was 616 nm, and solubility test in water (ammonia alkali) by filter paper spot was no less than 100 g/l.

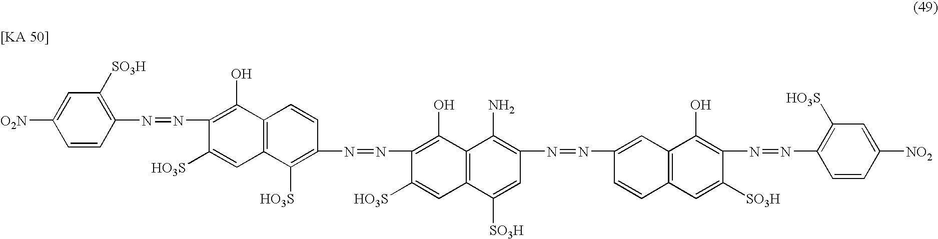

### EXAMPLES 10 TO 18

(A) Preparation of an Ink

An ink composition of the present invention was prepared by mixing each ingredient described below, and by filtering with a 0.45 μm membrane filter an ink composition for ink-jet printing was obtained.

TABLE 7

| | | |
|---|---|---|
| Black coloring matter obtained in the above each Example | 5.0 | part |
| (The one subjected to desalting treatment was used) | | |
| Glycerine | 5.0 | part |
| Urea | 5.0 | part |
| N-methyl-2-pyrrolidone | 4.0 | part |
| Isopropyl alcohol | 3.0 | part |
| Butylcarbitol | 2.0 | part |
| Surfactant | 0.1 | part |
| (Surfynol 105, from Nissin Chemical Industry Co., Ltd.) | | |
| Water + aqueous ammonia | 75.9 | part |
| Total | 100.0 | part |

In Table 7, “black coloring matter obtained in the above each Example” means respectively the compound of Formula (28) for Example 10, the compound of Formula (30) for Example 11, the compound of Formula (33) for Example 12, the compound of Formula (34) for Example 13, the compound of Formula (35) for Example 14, the compound of Formula (36) for Example 15, the compound of Formula (40) for Example 16, the compound of Formula (44) for Example 17, the compound of Formula (49) for Example 18. The pH in preparing an ink was adjusted at 8 to 10 with aqueous ammonia. The obtained ink composition of the present invention did not cause precipitation and separation during storage thereof, and did not cause change of physical property after storage for a long period of time.

(B) Ink-jet Printing

Using each of ink compositions obtained above, and by an ink-jet printer (Trade name BJ-S630 by Canon Inc.), ink-jet recording was conducted on three types of papers of a Plain Paper (Canon TLB5A4), Professional Glossy Paper A (Professional Photopaper PR-101 by Canon Inc.), and Professional Glossy Paper B (a paper for PM photograph (glossy), KA420PSK of Epson Co., Ltd.).

In printing, an image pattern was made so as to obtain gradations of several stages in reflection density, and a black colored print of half tone was obtained. As a gray scale mode is used in printing, each recording solution of yellow, cyan, and magenta other than a black recording solution was not used in this hypochromic part. In evaluation of hue density, which is an evaluation item using a calorimeter among testing methods described below, the highest portion of reflection density D value was used for colorimetry of this D value of a print. On measuring light fastness and ozone gas fastness which are evaluation items using a colorimeter similarly, measurement was conducted using a portion of gradations closest to 1.0 of reflection density, D value, of a print before the test is. Evaluations of hue, moisture fastness, and color rendering properties were conducted by visual observation on a print as a whole.

(C) Evaluation of a Recorded Image

Concerning a recorded image using an ink composition of the present invention, evaluation was conducted on 6 items of hue, hue density, change in hue after light fastness test, change in hue after ozone gas fastness test, bleeding degree due to moisture fastness test, and color rendering properties. In this connection, tests of ozone gas fastness and moisture fastness were conducted using only Professional Glossy Papers A and B. The results are shown in Table 8. The test methods are shown below.

(1) Evaluation of Hue and Hue Density

Hue of a recorded image was measured using Gretag Macbeth SpectroEye (from GRETAG Co., Ltd.) and hue density D value was calculated. Evaluations of hue were conducted by visual observation. Judgment of hue density was conducted, based on D value. Judgment criteria are shown below:

Evaluation of Hue

o: a good black color with almost no other color
Δ: a black color with slightly colored hue
x: a color which can not be called black

Evaluation of Hue Density:

| | | |
|---|---|---|
| ∘: | Plain Paper: 1.2 ≦ D, | Glossy Paper: 2.0 ≦ D |
| Δ: | Plain Paper: 1.0 ≦ D < 1.2, | Glossy Paper: 1.9 ≦ D < 2.0 |
| x: | Plain Paper: D < 1.0, | Glossy Paper: D < 1.9 |

(2) Light Fastness Test

Using a xenon weatherometer Ci4000 (from ATLAS Co., Ltd.), each print sample was irradiated for 50 hours at illuminance of 0.36 W/m². After the end of the test, colorimetry was conducted as described above, and color difference (ΔE) and color residual ratio of hue density before and after the test were measured. Residual ratio was calculated by residual ratio=D′/D×100 (%) when hue density before the test is D and hue density after the test is D′. Judgment criteria are shown below:
o: ΔE is lower than 10, and residual ratio is 80% or more
Δ: either one of ΔE or residual ratio does not satisfy the above condition for o
x: ΔE is 10 or more, and residual ratio is lower than 80%.
   (3) Ozone Fastness Test

Using an ozone weatherometer (from Suga Testing Machine Co., Ltd.), each print sample was left for 1 hour under conditions of ozone gas concentration of 12 ppm, humidity of 60% RH, and temperature of 24° C. After the end of the test, using the above described calorimetric system, color difference (ΔE) before and after the test and residual ratio of hue density were measured. Judgment criteria are shown below:
o: ΔE is lower than 15, and residual ratio is 80% or more
Δ: either one of ΔE or residual ratio does not satisfy the above conditions for o
x: ΔE is 15 or more, and residual ratio is lower than 80%
   (4) Moisture Fastness Test

Each print sample was left for 7 days at a temperature of 50° C. and at humidity of 90% RH, using a thermo-hygrostat (from Ouyogiken-Sangyo Co., Ltd.). Bleeding of a dye before and after the test was judged by visual observation:
o: little bleeding of a dye observed
Δ: slight bleeding of a dye observed
x: large bleeding of a dye observed.
   (5) Test of Color Rendering Properties

Based on hue under a standard light source, color change degree seen under a tungsten light was judged by visual observation:
o: small change in hue
Δ: relatively large change in hue
x: large change in hue

### COMPARATIVE EXAMPLE 1

Using, for comparison, an azo-based coloring matter, C.I. Food Black 2 (the following Formula (50)) which is used as a black coloring matter for water-soluble ink-jet, an ink composition was prepared by the same method for ink-composition as in Examples 10 to 18. The obtained evaluation results of hue, hue density, light fastness, and ozone gas fastness, moisture fastness and color rendering of a recorded image are shown in Table 8-1 and 8-2.

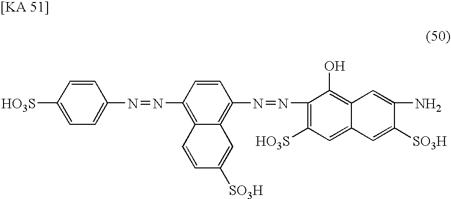

### COMPARATIVE EXAMPLE 2

Similarly, using, for comparison, a coloring matter shown in Example 2 of Patent Literature 6 (the following Formula (51)) as a coloring matter for water-soluble ink-jet, an ink composition was prepared by the same method for ink-composition as in Example 10 to 18. The obtained evaluation results of hue, hue density, light fastness, ozone gas fastness, moisture fastness and color rendering of a recorded image are shown in Table 8.

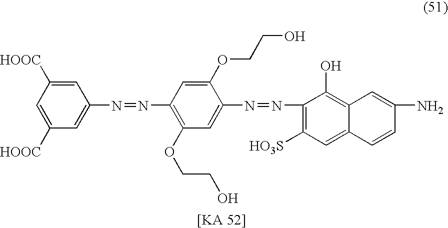

### COMPARATIVE EXAMPLE 3

Similarly, using, for comparison, a coloring matter shown in Example 3 of Patent Literature 7 (the following Formula (52)) as a coloring matter for water-soluble ink-jet, an ink composition was prepared by the same method for ink-composition as in Example 10 to 18. The obtained evaluation results of hue, hue density, light fastness, ozone gas fastness, moisture fastness and color rendering of a recorded image are shown in Table 8.

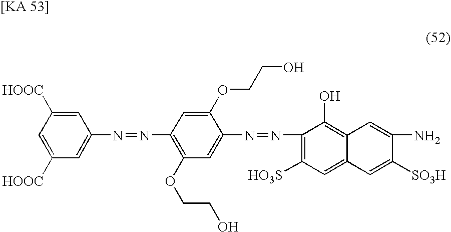

TABLE 8-1
Table 8-1

| | | | | | | color |
|---|---|---|---|---|---|---|
| | | Hue | Light | Ozone gas | Moisture | rendering |
| | Hue | Density | fastness | fastness | fastness | Properties |
| Example 10 (Formula (28)) | | | | | | |
| Plain Paper | ∘ | ∘ | ∘ | — | — | ∘ |
| Professional Glossy Paper A | ∘ | ∘ | ∘ | ∘ | ∘ | ∘ |
| Professional Glossy Paper B | ∘ | ∘ | ∘ | ∘ | ∘ | ∘ |
| Example 11 (Formula (30)) | | | | | | |
| Plain Paper | ∘ | ∘ | ∘ | — | — | ∘ |
| Professional Glossy Paper A | ∘ | ∘ | ∘ | ∘ | ∘ | ∘ |
| Professional Glossy Paper B | ∘ | ∘ | ∘ | ∘ | ∘ | ∘ |
| Example 12 (Formula (33)) | | | | | | |
| Plain Paper | ∘ | ∘ | ∘ | — | — | ∘ |
| Professional Glossy Paper A | ∘ | ∘ | ∘ | ∘ | ∘ | ∘ |
| Professional Glossy Paper B | ∘ | ∘ | ∘ | ∘ | ∘ | ∘ |
| Example 13 (Formula (34)) | | | | | | |
| Plain Paper | ∘ | ∘ | ∘ | — | — | ∘ |
| Professional Glossy Paper A | ∘ | ∘ | ∘ | ∘ | ∘ | ∘ |
| Professional Glossy Paper B | ∘ | ∘ | ∘ | ∘ | ∘ | ∘ |
| Example 14 (Formula (35)) | | | | | | |
| Plain Paper | ∘ | ∘ | ∘ | — | — | ∘ |
| Professional Glossy Paper A | ∘ | ∘ | ∘ | ∘ | ∘ | ∘ |
| Professional Glossy Paper B | ∘ | ∘ | ∘ | ∘ | ∘ | ∘ |
| Example 15 (Formula (36)) | | | | | | |
| Plain Paper | ∘ | ∘ | ∘ | — | — | ∘ |
| Professional Glossy Paper A | ∘ | ∘ | ∘ | ∘ | ∘ | ∘ |
| Professional Glossy Paper B | ∘ | ∘ | ∘ | ∘ | ∘ | ∘ |

TABLE 8-2
Table 8-2

| | | | | | | color |
|---|---|---|---|---|---|---|
| | | Hue | Light | Ozone gas | Moisture | rendering |
| | Hue | Density | fastness | fastness | fastness | Properties |
| Example 16 (Formula (40)) | | | | | | |
| Plain Paper | ∘ | ∘ | ∘ | — | — | ∘ |
| Professional Glossy Paper A | ∘ | ∘ | ∘ | ∘ | ∘ | ∘ |
| Professional Glossy Paper B | ∘ | ∘ | ∘ | ∘ | ∘ | ∘ |
| Example 17 (Formula (44)) | | | | | | |
| Plain Paper | ∘ | ∘ | ∘ | — | — | ∘ |
| Professional Glossy Paper A | ∘ | ∘ | ∘ | ∘ | ∘ | ∘ |
| Professional Glossy Paper B | ∘ | ∘ | ∘ | ∘ | ∘ | ∘ |
| Example 18 (Formula (49)) | | | | | | |
| Plain Paper | ∘ | ∘ | ∘ | — | — | ∘ |
| Professional Glossy Paper A | ∘ | ∘ | ∘ | ∘ | ∘ | ∘ |
| Professional Glossy Paper B | ∘ | ∘ | ∘ | ∘ | ∘ | ∘ |
| Comp. Ex. 1 (Formula (50)) | | | | | | |
| Plain Paper | ∘ | ∘ | ∘ | — | — | x |
| Professional Glossy Paper A | ∘ | Δ | ∘ | x | x | x |
| Professional Glossy Paper B | ∘ | Δ | ∘ | x | x | x |
| Comp. Ex. 2 (Formula (51)) | | | | | | |
| Plain Paper | Δ | ∘ | ∘ | — | — | x |
| Professional Glossy Paper A | Δ | ∘ | Δ | x | Δ | x |
| Professional Glossy Paper B | Δ | ∘ | ∘ | Δ | ∘ | x |
| Comp. Ex. 3 (Formula (52)) | | | | | | |
| Plain Paper | ∘ | ∘ | ∘ | | | x |
| Professional Glossy Paper A | ∘ | ∘ | ∘ | x | ∘ | x |
| Professional Glossy Paper B | ∘ | ∘ | ∘ | Δ | ∘ | x |

Judging from Table 8-1 and Table 8-2, an ink composition comprising a tetrakisazo compound of the present invention is comprehensively excellent in properties required for ink-jet recording such as hue, ozone gas fastness, light fastness, moisture fastness and color rendering, in comparison with conventional black dye (Comparative Examples)

### INDUSTRIAL APPLICABILITY

An ink composition comprising a tetrakisazo compound of the present invention is used as ink liquid for ink-jet recording and writing tools.

1. A coloring matter for recording represented by the following Formula (1) in the free acid form 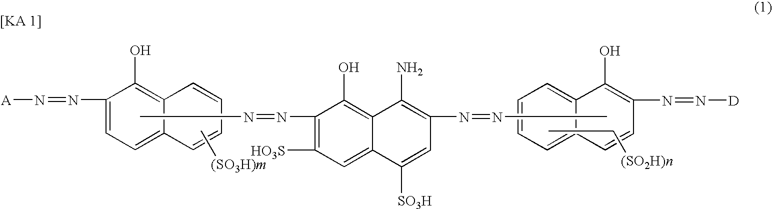
(wherein, each of A and D independently represents a phenyl group or a naphthyl group which may be substituted, and each of m and n represents 1 or 2).

2. A coloring matter for recording represented by the following Formula (2) in the free acid form 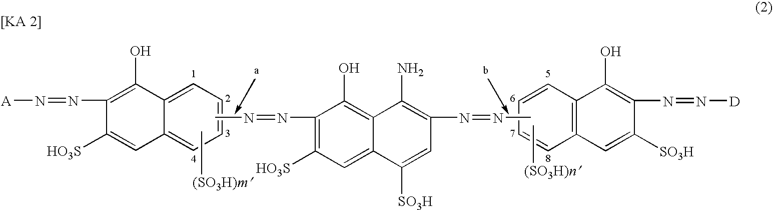
(wherein, each of A and D has the same meaning in Formula (1) of claim 1. Each of m′ and n′ represents 0 or 1. The bonding position of bond a is 2- or 3-position, and the bonding position of bond b is the 6- or 7-position).

3. The coloring matter for recording according to claim 2, wherein, in Formula (2), each of m′ and n′ represents 1, the bonding positions of said sulfo group are respectively 4-position and 8-position, the bonding position of bond a is 3-position, and the bonding position of bond b is 7-position.

4. The coloring matter for recording according to claim 1 or 2, wherein a substituent on A and D in Formula (1) or Formula (2) is a halogen atom; a hydroxyl group; an amino group; a carboxyl group; a sulfo group; a phosphono group; a nitro group; an alkyl group; an alkoxy group; an acyl group; a phenyl group; a ureide group; an alkyl group substituted with a hydroxyl group, an alkoxy group, a sulfo group or a carboxyl group; an alkoxy group substituted with a hydroxyl group, an alkoxy group, a sulfo group or a carboxyl group; a phenyl group which may be substituted with a carboxy group or a sulfo group; an amino group substituted with an alkyl group or an acyl group; a benzothiazole group; a mesyl group; or a sulfamoyl group.

5. The coloring matter for recording according to claim 1 or 2, wherein each of A and D of Formula (1) or Formula (2) is independently a phenyl group or a naphthyl group which may be substituted with groups selected from a halogen atom, a carboxyl group, a sulfo group, a nitro group, an alkoxy group, a sulfoalkoxy group, an acylamino group, a benzothiazole group, a mesyl group, or a sulfamoyl group.

6. The coloring matter for recording according to any one of claims 1 or 2, wherein each of A and D in Formula (1) or Formula (2) is a phenyl group or a naphthyl group substituted with one or more carboxyl groups or sulfo groups.

7. The coloring matter for recording according to claim 2, wherein each of A and D in Formula (2) is a phenyl group which has a sulfo group or a carboxyl group at 2-position to an azo group and a hydrogen atom, a nitro group or an alkoxy group at 4-position to an azo group; or a phenyl group which has carboxyl groups at 2-position and 5-position or at 3-position and 5-position to an azo group, and when m′ is 1, the bonding position is 3-position or the 4-position, and when n′ is 1, the bonding position is 7-position or 8-position.

8. An ink composition characterized by comprising the coloring matter for recording according to any one of claims 1 or 2.

9. An recording method for ink-jet printing characterized by using the ink composition according to claim 8 as an ink in a method for ink-jet recording where recording is conducted on a record-receiving material by jetting ink droplet in response to a recording signal.

10. The recording method for ink-jet printing according to claim 9, wherein a record-receiving material is a sheet for transmitting information.

11. An ink-jet printer loaded with a container containing the ink composition according to claim 8.

12. A colored article colored with the coloring matter for recording according to any one of claims 1 or 2.

13. A tetrakisazo compound represented by the following Formula (1′) or a salt thereof 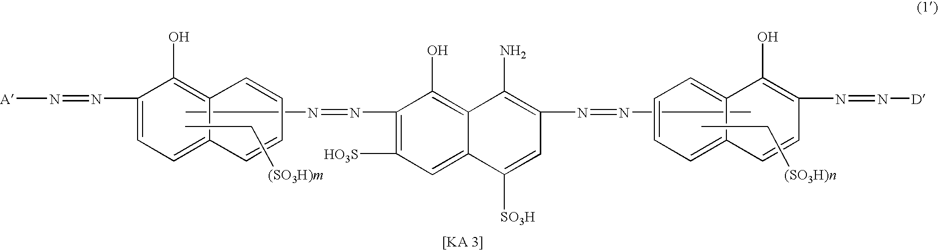
(wherein, each of A′ and D′ independently represents a phenyl group or a naphthyl group, which may be substituted with a halogen atom; a hydroxyl group; an amino group; a carboxyl group; a sulfo group; a nitro group; an alkyl group; an alkoxy group; an acyl group; a phenyl group; a ureide group; an alkyl group substituted with a hydroxyl group, an alkoxy group, a sulfo group or a carboxyl group; an alkoxy group substituted with a hydroxyl group, an alkoxy group, a sulfo group or a carboxyl group; an amino group substituted with a phenyl group which may be substituted with a carboxyl group or a sulfo group, an alkyl group or an acyl group; an benzothiazole group; a mesyl group; or a sulfamoyl group. m and n represent 1 or 2).

14. The tetrakisazo compound or the salt thereof according to claim 13, wherein A′ and D′ in Formula (1′) are a halogen atom; a hydroxyl group; a lower acylamino group; a carboxyl group; a sulfo group; a nitro group; a lower alkyl group; a lower alkoxy group which may be substituted with a sulfo group; a benzothiazole group which may have a lower alkyl group or a sulfo group on a benzene nucleus as a substituent; a phenyl group or a naphthyl group which may be substituted with 1 to 3 of substituents selected from a group consisting of a phosphono group, a mesyl group and a sulfamoyl group.

15. The tetrakisazo compound or the salt thereof according to claim 14, wherein the naphthyl groups on the left and right sides substituted with the azo group in Formula (1′) are bound at the 3-position and the 7-position respectively to the azo group bound to a naphthyl group in the center, where the 3-position and the 7-position represent the positions when the naphthyl groups are assigned the same number as in the above Formula (2).

16. The tetrakisazo compound or the salt thereof according to claim 13, wherein each of A′ and D′ in Formula (1′) is a phenyl group or a naphthyl group substituted with one or more carboxyl groups or sulfo groups.

17. A tetrakisazo compound according to claim 13 represented by the following Formula (a) in the free acid form or a salt thereof 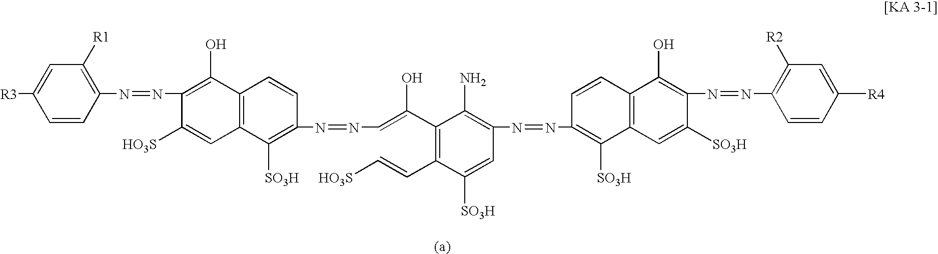
(wherein, each of R1 and R2 independently represents a hydrogen atom, a sulfo group or a carboxyl group, each of R3 and R4 independently represents a nitro group, a lower alkylsulfonyl group or a sulfamoyl group).

18. The tetrakisazo compound or the salt thereof according to claim 17, wherein, in Formula (a), R1 and R2 represent the same groups selected from a hydrogen atom, a sulfo group or a carboxyl group, and R3 and R4 are the same groups selected from a nitro group, a mesyl group or a sulfamoyl group.

19. The tetrakisazo compound or the salt thereof according to claim 18, wherein in Formula (a), R3 and R4 are sulfamoyl groups or mesyl groups when R1 and R2 are hydrogen atoms, R3 and R4 are sulfamoyl groups when R1 and R2 are carboxyl groups, and R3 and R4 are nitro groups when R1 and R2 are sulfo groups.
